(19) United States
(12) Patent Application Publication
(10) Pub. No.: US 2025/0208902 A1
(43) Pub. Date: Jun. 26, 2025

(54) DEVICE, METHOD AND SYSTEM TO PROVIDE PREDICTION STATE INFORMATION OF A PROCESSOR

(71) Applicant: Intel Corporation, Santa Clara, CA (US)

(72) Inventors: Ke Sun, Portland, OR (US); Alyssa Milburn, Den Haag (NL); Henrique De Medeiros Kawakami, Seattle, WA (US); Jason W. Brandt, Austin, TX (US); Thais Moreira Hamasaki, Seattle, WA (US)

(73) Assignee: Intel Corporation, Santa Clara, CA (US)

(21) Appl. No.: 18/396,415

(22) Filed: Dec. 26, 2023

(51) Int. Cl. G06F 9/48; G06F 9/38

(52) U.S. Cl. CPC G06F 9/485; G06F 9/3848

(57) ABSTRACT

Techniques and mechanisms for automatically saving and recovering microarchitectural prediction state information of a processor core. In an embodiment, a core comprises prediction circuitry which generates microarchitectural prediction state information based on an execution of a software process by the core. A prediction state manager of the processor detects a context switch of the processor and, based on such detection, automatically saves a version of the microarchitectural prediction state information to a repository which is external to the core. The microarchitectural prediction state information is available to be recovered from the repository to facilitate a resumed execution of the software process. In another embodiment, the microarchitectural prediction state information is saved to, or recovered from, the repository independent of an instruction of the software process, if any, which specifies that such saving or recovery is to be performed.

### BACKGROUND

### 1. Technical Field

This disclosure generally relates to processors and more particularly, but not exclusively, to the saving and recovery of microarchitectural state of a processor core.

### 2. Background Art

Many processor architectures utilize prediction functionality, such as branch prediction and branch target prediction, to improve performance by mitigating the risk of execution pipeline stalls. Such prediction functionality enables speculative execution to continue without having to wait for an architectural resolution of a branch condition or a branch target.

Currently, prediction circuitry-including branch predictors, branch target predictors, prediction arrays, etc.—is thread and/or core scoped, meaning that the prediction data generated in one core cannot be used on a different core (and/or used in a different thread if the prediction circuitry has thread-isolation). Therefore, when execution of a software process is scheduled by an operation system (OS) to be migrated from a first processor core to a second processor core, the software process will lose the benefit of the prediction state which was at the first processor core due to such execution.

Moreover, conventional prediction circuitry is not context-aware, at least with respect to the software context of a given task, process, or thread. For example, existing processor designs do not provide predictors which are aware of the current software context. Furthermore, branch prediction arrays do not provide information which identifies the particular execution context (e.g., software process) to which they currently belong. As successive generations of computer systems continue to increase in number, variety, and capability, there is expected to be an increasing premium placed on improvements to efficient execution of multiple software contexts.

### BRIEF DESCRIPTION OF THE DRAWINGS

The various embodiments of the present invention are illustrated by way of example, and not by way of limitation, in the figures of the accompanying drawings and in which:

FIG. 1 illustrates an exemplary system to provide prediction state information according to an embodiment.

FIG. 2 illustrates a block diagram of an example processor that, according to an embodiment, may have more than one core and an integrated memory controller.

FIG. 3A is a block diagram illustrating both an exemplary in-order pipeline and an exemplary register renaming, out-of-order issue/execution pipeline according to an embodiment.

FIG. 3B is a block diagram illustrating both an exemplary example of an in-order architecture core and an exemplary register renaming, out-of-order issue/execution architecture core to be included in a processor according to an embodiment.

FIG. 4 illustrates examples of execution unit(s) circuitry of a processor according to an embodiment.

FIG. 5 is a block diagram of a register architecture of a processor according to an embodiment.

FIG. 6 shows a block diagram illustrating features of a system to provide access to microarchitectural prediction state information according to an embodiment.

FIG. 7 shows a flow diagram illustrating features of a method to manage prediction state information according to an embodiment.

FIG. 8 shows a block diagram illustrating features of a system to automatically save and protect microarchitectural prediction state information according to an embodiment.

FIG. 9 shows a block diagram illustrating features of a system 900 to trigger a buffering of microarchitectural prediction state information according to an embodiment.

FIG. 10 shows a block diagram illustrating features of a device 1000 to manage access to prediction state information according to an embodiment.

FIGS. 11A-11C are hybrid block and timing diagrams showing various operations performed each during a respective one of multiple stages of operations to share prediction state information among processor cores according to an embodiment.

FIGS. 12A-12C are hybrid block and timing diagrams showing various operations performed each during a respective one of multiple stages of operations to save and recover prediction state information according to an embodiment.

### DETAILED DESCRIPTION

Embodiments discussed herein variously provide techniques and mechanisms for efficiently saving and recovering microarchitectural prediction state information of a processor core. In an embodiment, a core of a processor comprises prediction circuitry which plays a critical role in branch prediction, branch target prediction, and/or the like—e.g., to provide a predicted instruction pointer (IP) to a front-end (FE) of the core. For example, such prediction circuitry comprises one or more predictors—e.g., including one or more of a branch target buffer or “BTB” (sometimes referred to as a “target array” or “TA”), a conditional branch predictor, an indirect branch predictor, a return stack buffer (RSB), etc.—for prediction of different types of branches, and to provide prediction arrays that save the prediction results based on previous execution history.

In one such embodiment, the processor further comprises circuitry (referred to herein as a “prediction state manager”) which automatically triggers a saving of some or all of a current state of such prediction circuitry. In an embodiment, a prediction state manager is coupled to receive an indication of a context switch event—e.g., actual or predicted-which saves architectural state of a process that is executed with a given processor core. By way of illustration and not limitation, operating systems (OSs) typically use time slicing to schedule multiple successive processes on the same processor core, meaning different processes get executed intermittently, one after another with a certain time slice every time they get scheduled, and repeat until execution completes. In one such embodiment, an indication of a context switch event includes or is otherwise based on a signal which is communicated, from a scheduler of such an OS, based on an expiration of a given time slice.

Based on an indication of a context switch event (and, for example, based on a particular type of types of prediction context information to be saved), the prediction state manager performs operations to save some or all of the state of prediction circuitry of that processor core. In an embodiment, such state (referred to herein as “prediction state information”) is saved to any of various suitable repositories, such as a storage resource of the processor, a main memory resource, or the like. The prediction state information is available to be recovered from such a repository at a later time—e.g., wherein the prediction state manager writes the saved prediction state information back to the same processor core or, alternatively, to a different processor core.

Given that the branch predictors are not context-aware, branch prediction entries that belong to one process will-under current processor designs-keep getting overwritten by other processes in conventional time-slice scheduling techniques. By contrast, some embodiments variously preserve microarchitectural prediction state of a core, which facilitates efficient resumption of speculative execution after a later context switch resumes the execution of a previously-executing process.

One example application for some embodiments is typically run in multi-tenant datacenter environments, which are often characterized by interpreted and just-in-time (JIT) compiled codes, by numerous background (micro) services—e.g., multiple threads and/or function-as-a-service (FaaS) applications—and/or by large instruction footprints. Servers today often suffer from major instruction supply bottlenecks, high frequency context switches and high address translation overheads, usually as part of a highly virtualized container-based execution. Unfortunately, processor design places a great focus on improving performance of traditional SPEChpc-like benchmarks, without taking into consideration various aspects of the overall datacenter ecosystem and its evolution.

Microservices and Function-as-a-Service (FAAS) based applications have emerged as an important category of applications. Netflix, Twitter, Facebook, Amazon Lambda, Microsoft Azure are some examples of server/cloud-based companies that have adopted a microservices and FaaS models to build their software ecosystem. The characteristics of these applications—e.g., in terms of code length, being monolithic code-based, static compiled versus interpreted, etc.—have underlying implications which impact processor core performance.

One characteristic of disaggregated application technologies—such as microservices and Function-as-a-Service (FAAS) based applications—is that, as functionalities are broken into separate tasks (often functions that perform specific operation), the duration of each of these tasks is often relatively short. As such, there is significant time involved in (re) initialization—sometimes referred to as “warmup”—of a CPU's microarchitecture state, soon after which the task itself terminates. Hence, such tasks rarely operate with high microarchitecture efficiency on account of their relatively short duration of execution, and on account of ultra-fast context switching in these execution environments. Given that some types of application variously utilize several instances of the same function, different embodiments variously provide an opportunity for significant performance improvement where the repeated initialization cost can be avoided.

Some embodiments dramatically reduce the (re) initialization cost (such as that which impacts function-based services) by enabling an automatic saving and recovering of microarchitectural prediction state. For example, a prediction state manager circuit of a processor is configured to trigger a saving (or recovery) of microarchitectural prediction state based on an indication of a context switch event. In various embodiments, such triggering is automatic at least insofar as it is independent of the execution of any instruction (or at least any instruction of the process being switched from) which explicitly requests or otherwise specifies that such saving/recovering is to be performed.

In various embodiments, a core of a processor comprises first circuit resources (referred to herein as “front-end resources,” or simply as a “front-end”) which provide functionality to fetch and decode instructions. For example, a front-end of a processor core comprises a fetch unit to fetch instructions from a memory, and a decoder to decode the instructions. In one such embodiment, the processor core further comprises second circuit resources (referred to herein as “back-end resources,” or simply as a “back-end”) which provide functionality to execute some or all of the decoded instructions which are provided by the first circuit resources.

As used herein in the context of prediction state information, the term “microarchitectural state” (sometimes referred to as “microarchitectural context”) is to be distinguished, for example, from the term “architectural state.” Microarchitectural state includes some internal state of one or more components of a processor core—e.g., where said internal state results at least in part from the execution of a given sequence of instructions. However, this internal state of the processor core is to be distinguished from the state of execution of the sequence itself. For example, microarchitectural state is typically not exposed outside of the processor in question. By contrast, architectural state typically includes information—in various register files and/or memory-which represents the state of execution of a particular sequence of instructions.

The technologies described herein may be implemented in one or more electronic devices. Non-limiting examples of electronic devices that may utilize the technologies described herein include any kind of mobile device and/or stationary device, such as cameras, cell phones, computer terminals, desktop computers, electronic readers, facsimile machines, kiosks, laptop computers, netbook computers, notebook computers, internet devices, payment terminals, personal digital assistants, media players and/or recorders, servers (e.g., blade server, rack mount server, combinations thereof, etc.), set-top boxes, smart phones, tablet personal computers, ultra-mobile personal computers, wired telephones, combinations thereof, and the like. More generally, the technologies described herein may be employed in any of a variety of electronic devices including a processor which supports an automatic saving and recovering of prediction state information.

### Exemplary Computer Architectures.

Detailed below are describes of exemplary computer architectures to provide prediction state information according to an embodiment. Other system designs and configurations known in the arts for laptop, desktop, and handheld personal computers (PC)s, personal digital assistants, engineering workstations, servers, disaggregated servers, network devices, network hubs, switches, routers, embedded processors, digital signal processors (DSPs), graphics devices, video game devices, set-top boxes, micro controllers, cell phones, portable media players, hand-held devices, and various other electronic devices, are also suitable. In general, a variety of systems or electronic devices capable of incorporating a processor and/or other execution logic as disclosed herein are generally suitable.

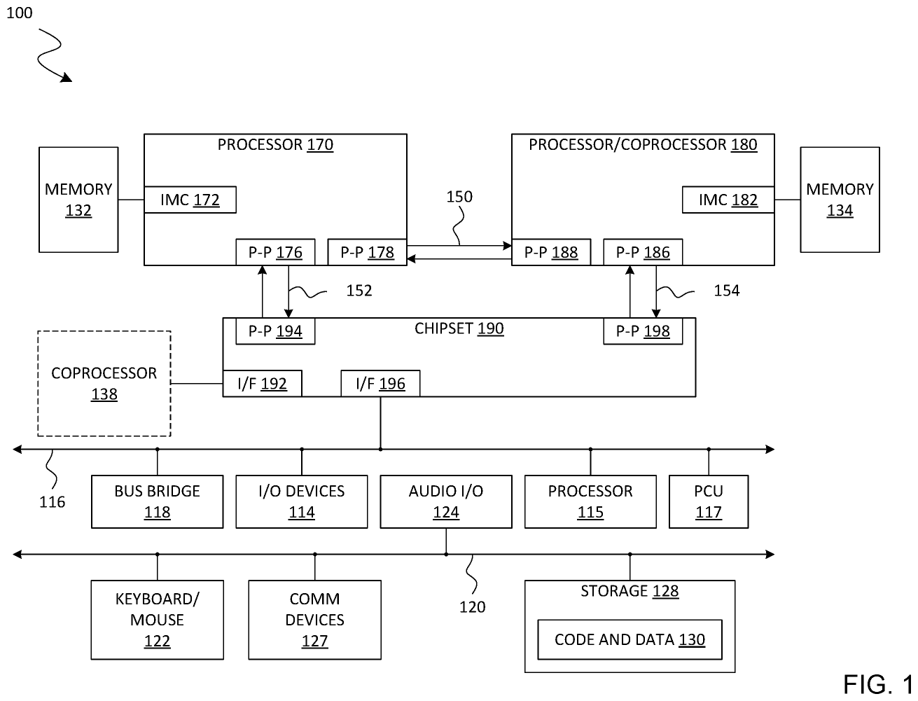

FIG. 1 illustrates an exemplary system. Multiprocessor system 100 is a point-to-point interconnect system and includes a plurality of processors including a first processor 170 and a second processor 180 coupled via a point-to-point interconnect 150. In some examples, the first processor 170 and the second processor 180 are homogeneous. In some examples, first processor 170 and the second processor 180 are heterogenous. Though the exemplary system 100 is shown to have two processors, the system may have three or more processors, or may be a single processor system.

Processors 170 and 180 are shown including integrated memory controller (IMC) circuitry 172 and 182, respectively. Processor 170 also includes as part of its interconnect controller point-to-point (P-P) interfaces 176 and 178; similarly, second processor 180 includes P-P interfaces 186 and 188. Processors 170, 180 may exchange information via the point-to-point (P-P) interconnect 150 using P-P interface circuits 178, 188. IMCs 172 and 182 couple the processors 170, 180 to respective memories, namely a memory 132 and a memory 134, which may be portions of main memory locally attached to the respective processors.

Processors 170, 180 may each exchange information with a chipset 190 via individual P-P interconnects 152, 154 using point to point interface circuits 176, 194, 186, 198. Chipset 190 may optionally exchange information with a coprocessor 138 via an interface 192. In some examples, the coprocessor 138 is a special-purpose processor, such as, for example, a high-throughput processor, a network or communication processor, compression engine, graphics processor, general purpose graphics processing unit (GPGPU), neural-network processing unit (NPU), embedded processor, or the like.

A shared cache (not shown) may be included in either processor 170, 180 or outside of both processors, yet connected with the processors via P-P interconnect, such that either or both processors' local cache information may be stored in the shared cache if a processor is placed into a low power mode.

Chipset 190 may be coupled to a first interconnect 116 via an interface 196. In some examples, first interconnect 116 may be a Peripheral Component Interconnect (PCI) interconnect, or an interconnect such as a PCI Express interconnect or another I/O interconnect. In some examples, one of the interconnects couples to a power control unit (PCU) 117, which may include circuitry, software, and/or firmware to perform power management operations with regard to the processors 170, 180 and/or co-processor 138. PCU 117 provides control information to a voltage regulator (not shown) to cause the voltage regulator to generate the appropriate regulated voltage. PCU 117 also provides control information to control the operating voltage generated. In various examples, PCU 117 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 117 is illustrated as being present as logic separate from the processor 170 and/or processor 180. In other cases, PCU 117 may execute on a given one or more of cores (not shown) of processor 170 or 180. In some cases, PCU 117 may be implemented as a microcontroller (dedicated or general-purpose) or other control logic configured to execute its own dedicated power management code, sometimes referred to as P-code. In yet other examples, power management operations to be performed by PCU 117 may be implemented externally to a processor, such as by way of a separate power management integrated circuit (PMIC) or another component external to the processor. In yet other examples, power management operations to be performed by PCU 117 may be implemented within BIOS or other system software.

Various I/O devices 114 may be coupled to first interconnect 116, along with a bus bridge 118 which couples first interconnect 116 to a second interconnect 120. In some examples, one or more additional processor(s) 115, such as coprocessors, high-throughput many integrated core (MIC) processors, GPGPUs, accelerators (such as graphics accelerators or digital signal processing (DSP) units), field programmable gate arrays (FPGAs), or any other processor, are coupled to first interconnect 116. In some examples, second interconnect 120 may be a low pin count (LPC) interconnect. Various devices may be coupled to second interconnect 120 including, for example, a keyboard and/or mouse 122, communication devices 127 and a storage circuitry 128. Storage circuitry 128 may be one or more non-transitory machine-readable storage media as described below, such as a disk drive or other mass storage device which may include instructions/code and data 130 in some examples. Further, an audio I/O 124 may be coupled to second interconnect 120. Note that other architectures than the point-to-point architecture described above are possible. For example, instead of the point-to-point architecture, a system such as multiprocessor system 100 may implement a multi-drop interconnect or other such architecture.

### Exemplary Core Architectures, Processors, and Computer Architectures.

Processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput) computing. Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip (SoC) that may include on the same die as the described CPU (sometimes referred to as the application core(s) or application processor(s)), the above described coprocessor, and additional functionality. Exemplary core architectures are described next, followed by descriptions of exemplary processors and computer architectures.

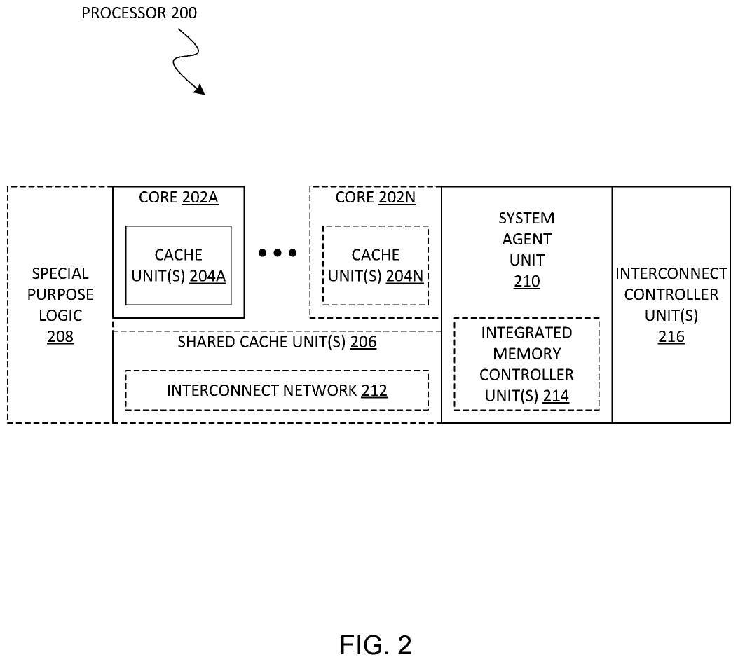

FIG. 2 illustrates a block diagram of an example processor 200 that may have more than one core and an integrated memory controller. The solid lined boxes illustrate a processor 200 with a single core 202A, a system agent unit circuitry 210, a set of one or more interconnect controller unit(s) circuitry 216, while the optional addition of the dashed lined boxes illustrates an alternative processor 200 with multiple cores 202A-N, a set of one or more integrated memory controller unit(s) circuitry 214 in the system agent unit circuitry 210, and special purpose logic 208, as well as a set of one or more interconnect controller units circuitry 216. Note that the processor 200 may be one of the processors 170 or 180, or co-processor 138 or 115 of FIG. 1.

Thus, different implementations of the processor 200 may include: 1) a CPU with the special purpose logic 208 being integrated graphics and/or scientific (throughput) logic (which may include one or more cores, not shown), and the cores 202A-N being one or more general purpose cores (e.g., general purpose in-order cores, general purpose out-of-order cores, or a combination of the two); 2) a coprocessor with the cores 202A-N being a large number of special purpose cores intended primarily for graphics and/or scientific (throughput); and 3) a coprocessor with the cores 202A-N being a large number of general purpose in-order cores. Thus, the processor 200 may be a general-purpose processor, coprocessor or special-purpose processor, such as, for example, a network or communication processor, compression engine, graphics processor, GPGPU (general purpose graphics processing unit circuitry), a high-throughput many integrated core (MIC) coprocessor (including 30 or more cores), embedded processor, or the like. The processor may be implemented on one or more chips. The processor 200 may be a part of and/or may be implemented on one or more substrates using any of a number of process technologies, such as, for example, complementary metal oxide semiconductor (CMOS), bipolar CMOS (BiCMOS), P-type metal oxide semiconductor (PMOS), or N-type metal oxide semiconductor (NMOS).

A memory hierarchy includes one or more levels of cache unit(s) circuitry 204A-N within the cores 202A-N, a set of one or more shared cache unit(s) circuitry 206, and external memory (not shown) coupled to the set of integrated memory controller unit(s) circuitry 214. The set of one or more shared cache unit(s) circuitry 206 may include one or more mid-level caches, such as level 2 (L2), level 3 (L3), level 4 (L4), or other levels of cache, such as a last level cache (LLC), and/or combinations thereof. While in some examples ring-based interconnect network circuitry 212 interconnects the special purpose logic 208 (e.g., integrated graphics logic), the set of shared cache unit(s) circuitry 206, and the system agent unit circuitry 210, alternative examples use any number of well-known techniques for interconnecting such units. In some examples, coherency is maintained between one or more of the shared cache unit(s) circuitry 206 and cores 202A-N.

In some examples, one or more of the cores 202A-N are capable of multi-threading. The system agent unit circuitry 210 includes those components coordinating and operating cores 202A-N. The system agent unit circuitry 210 may include, for example, power control unit (PCU) circuitry and/or display unit circuitry (not shown). The PCU may be or may include logic and components needed for regulating the power state of the cores 202A-N and/or the special purpose logic 208 (e.g., integrated graphics logic). The display unit circuitry is for driving one or more externally connected displays.

The cores 202A-N may be homogenous in terms of instruction set architecture (ISA). Alternatively, the cores 202A-N may be heterogeneous in terms of ISA; that is, a subset of the cores 202A-N may be capable of executing an ISA, while other cores may be capable of executing only a subset of that ISA or another ISA.

### Exemplary Core Architectures-In-Order and Out-of-Order Core Block Diagram.

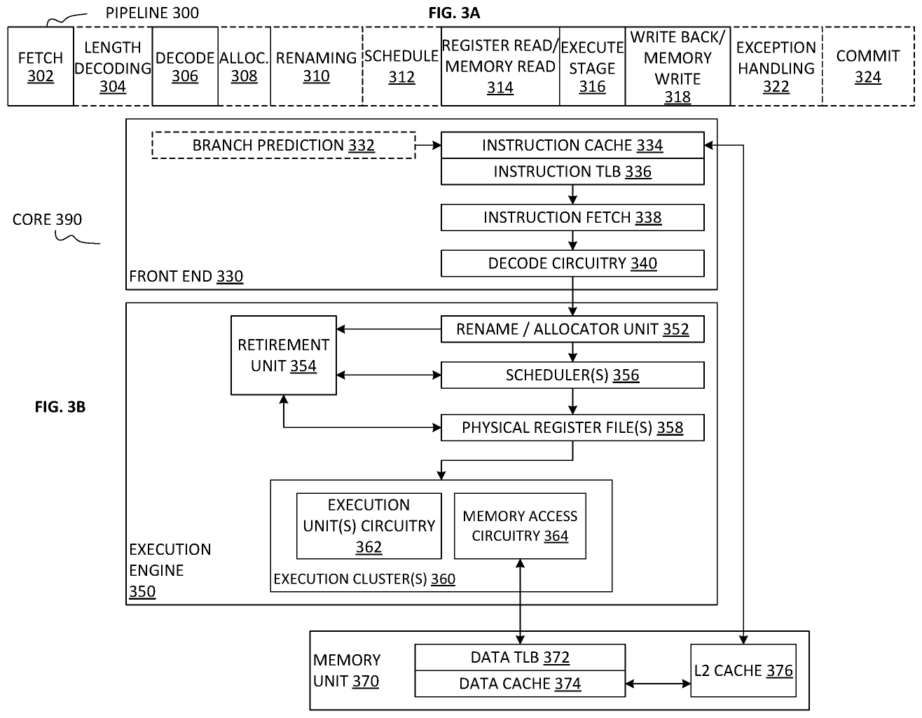

FIG. 3A is a block diagram illustrating both an exemplary in-order pipeline and an exemplary register renaming, out-of-order issue/execution pipeline according to examples. FIG. 3B is a block diagram illustrating both an exemplary example of an in-order architecture core and an exemplary register renaming, out-of-order issue/execution architecture core to be included in a processor according to examples. The solid lined boxes in FIGS. 3A-B illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 3A, a processor pipeline 300 includes a fetch stage 302, an optional length decoding stage 304, a decode stage 306, an optional allocation (Alloc) stage 308, an optional renaming stage 310, a schedule (also known as a dispatch or issue) stage 312, an optional register read/memory read stage 314, an execute stage 316, a write back/memory write stage 318, an optional exception handling stage 322, and an optional commit stage 324. One or more operations can be performed in each of these processor pipeline stages. For example, during the fetch stage 302, one or more instructions are fetched from instruction memory, and during the decode stage 306, the one or more fetched instructions may be decoded, addresses (e.g., load store unit (LSU) addresses) using forwarded register ports may be generated, and branch forwarding (e.g., immediate offset or a link register (LR)) may be performed. In one example, the decode stage 306 and the register read/memory read stage 314 may be combined into one pipeline stage. In one example, during the execute stage 316, the decoded instructions may be executed, LSU address/data pipelining to an Advanced Microcontroller Bus (AMB) interface may be performed, multiply and add operations may be performed, arithmetic operations with branch results may be performed, etc.

By way of example, the exemplary register renaming, out-of-order issue/execution architecture core of FIG. 3B may implement the pipeline 300 as follows: 1) the instruction fetch circuitry 338 performs the fetch and length decoding stages 302 and 304; 2) the decode circuitry 340 performs the decode stage 306; 3) the rename/allocator unit circuitry 352 performs the allocation stage 308 and renaming stage 310; 4) the scheduler(s) circuitry 356 performs the schedule stage 312; 5) the physical register file(s) circuitry 358 and the memory unit circuitry 370 perform the register read/memory read stage 314; the execution cluster(s) 360 perform the execute stage 316; 6) the memory unit circuitry 370 and the physical register file(s) circuitry 358 perform the write back/memory write stage 318; 7) various circuitry may be involved in the exception handling stage 322; and 8) the retirement unit circuitry 354 and the physical register file(s) circuitry 358 perform the commit stage 324.

FIG. 3B shows a processor core 390 including front-end unit circuitry 330 coupled to an execution engine unit circuitry 350, and both are coupled to a memory unit circuitry 370. The core 390 may be a reduced instruction set architecture computing (RISC) core, a complex instruction set architecture computing (CISC) core, a very long instruction word (VLIW) core, or a hybrid or alternative core type. As yet another option, the core 390 may be a special-purpose core, such as, for example, a network or communication core, compression engine, coprocessor core, general purpose computing graphics processing unit (GPGPU) core, graphics core, or the like.

The front end unit circuitry 330 may include branch prediction circuitry 332 coupled to an instruction cache circuitry 334, which is coupled to an instruction translation lookaside buffer (TLB) 336, which is coupled to instruction fetch circuitry 338, which is coupled to decode circuitry 340. In one example, the instruction cache circuitry 334 is included in the memory unit circuitry 370 rather than the front-end circuitry 330. The decode circuitry 340 (or decoder) may decode instructions, and generate as an output one or more micro-operations, micro-code entry points, microinstructions, other instructions, or other control signals, which are decoded from, or which otherwise reflect, or are derived from, the original instructions. The decode circuitry 340 may further include an address generation unit (AGU, not shown) circuitry. In one example, the AGU generates an LSU address using forwarded register ports, and may further perform branch forwarding (e.g., immediate offset branch forwarding, LR register branch forwarding, etc.). The decode circuitry 340 may be implemented using various different mechanisms. Examples of suitable mechanisms include, but are not limited to, look-up tables, hardware implementations, programmable logic arrays (PLAs), microcode read only memories (ROMs), etc. In one example, the core 390 includes a microcode ROM (not shown) or other medium that stores microcode for certain macroinstructions (e.g., in decode circuitry 340 or otherwise within the front end circuitry 330). In one example, the decode circuitry 340 includes a micro-operation (micro-op) or operation cache (not shown) to hold/cache decoded operations, micro-tags, or micro-operations generated during the decode or other stages of the processor pipeline 300. The decode circuitry 340 may be coupled to rename/allocator unit circuitry 352 in the execution engine circuitry 350.

The execution engine circuitry 350 includes the rename/allocator unit circuitry 352 coupled to a retirement unit circuitry 354 and a set of one or more scheduler(s) circuitry 356. The scheduler(s) circuitry 356 represents any number of different schedulers, including reservations stations, central instruction window, etc. In some examples, the scheduler(s) circuitry 356 can include arithmetic logic unit (ALU) scheduler/scheduling circuitry, ALU queues, arithmetic generation unit (AGU) scheduler/scheduling circuitry, AGU queues, etc. The scheduler(s) circuitry 356 is coupled to the physical register file(s) circuitry 358. Each of the physical register file(s) circuitry 358 represents one or more physical register files, different ones of which store one or more different data types, such as scalar integer, scalar floating-point, packed integer, packed floating-point, vector integer, vector floating-point, status (e.g., an instruction pointer that is the address of the next instruction to be executed), etc. In one example, the physical register file(s) circuitry 358 includes vector registers unit circuitry, writemask registers unit circuitry, and scalar register unit circuitry. These register units may provide architectural vector registers, vector mask registers, general-purpose registers, etc. The physical register file(s) circuitry 358 is coupled to the retirement unit circuitry 354 (also known as a retire queue or a retirement queue) to illustrate various ways in which register renaming and out-of-order execution may be implemented (e.g., using a reorder buffer(s) (ROB(s)) and a retirement register file(s); using a future file(s), a history buffer(s), and a retirement register file(s); using a register maps and a pool of registers; etc.). The retirement unit circuitry 354 and the physical register file(s) circuitry 358 are coupled to the execution cluster(s) 360. The execution cluster(s) 360 includes a set of one or more execution unit(s) circuitry 362 and a set of one or more memory access circuitry 364. The execution unit(s) circuitry 362 may perform various arithmetic, logic, floating-point or other types of operations (e.g., shifts, addition, subtraction, multiplication) and on various types of data (e.g., scalar integer, scalar floating-point, packed integer, packed floating-point, vector integer, vector floating-point). While some examples may include a number of execution units or execution unit circuitry dedicated to specific functions or sets of functions, other examples may include only one execution unit circuitry or multiple execution units/execution unit circuitry that all perform all functions. The scheduler(s) circuitry 356, physical register file(s) circuitry 358, and execution cluster(s) 360 are shown as being possibly plural because certain examples create separate pipelines for certain types of data/operations (e.g., a scalar integer pipeline, a scalar floating-point/packed integer/packed floating-point/vector integer/vector floating-point pipeline, and/or a memory access pipeline that each have their own scheduler circuitry, physical register file(s) circuitry, and/or execution cluster—and in the case of a separate memory access pipeline, certain examples are implemented in which only the execution cluster of this pipeline has the memory access unit(s) circuitry 364). It should also be understood that where separate pipelines are used, one or more of these pipelines may be out-of-order issue/execution and the rest in-order.

In some examples, the execution engine unit circuitry 350 may perform load store unit (LSU) address/data pipelining to an Advanced Microcontroller Bus (AMB) interface (not shown), and address phase and writeback, data phase load, store, and branches.

The set of memory access circuitry 364 is coupled to the memory unit circuitry 370, which includes data TLB circuitry 372 coupled to a data cache circuitry 374 coupled to a level 2 (L2) cache circuitry 376. In one exemplary example, the memory access circuitry 364 may include a load unit circuitry, a store address unit circuit, and a store data unit circuitry, each of which is coupled to the data TLB circuitry 372 in the memory unit circuitry 370. The instruction cache circuitry 334 is further coupled to the level 2 (L2) cache circuitry 376 in the memory unit circuitry 370. In one example, the instruction cache 334 and the data cache 374 are combined into a single instruction and data cache (not shown) in L2 cache circuitry 376, a level 3 (L3) cache circuitry (not shown), and/or main memory. The L2 cache circuitry 376 is coupled to one or more other levels of cache and eventually to a main memory.

The core 390 may support one or more instructions sets (e.g., the x86 instruction set architecture (optionally with some extensions that have been added with newer versions); the MIPS instruction set architecture; the ARM instruction set architecture (optionally with optional additional extensions such as NEON)), including the instruction(s) described herein. In one example, the core 390 includes logic to support a packed data instruction set architecture extension (e.g., AVX1, AVX2), thereby allowing the operations used by many multimedia applications to be performed using packed data.

### Exemplary Execution Unit(s) Circuitry.

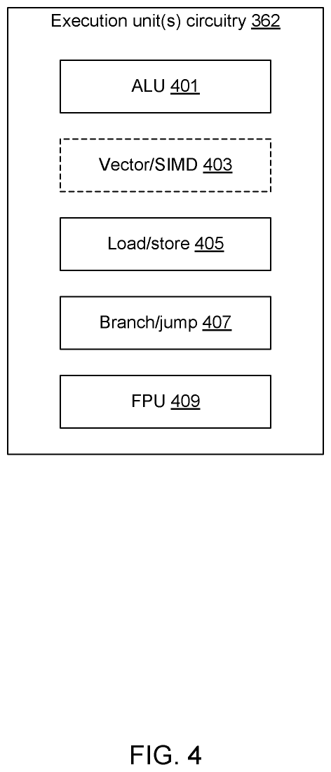

FIG. 4 illustrates examples of execution unit(s) circuitry, such as execution unit(s) circuitry 362 of FIG. 3B. As illustrated, execution unit(s) circuitry 362 may include one or more ALU circuits 401, optional vector/single instruction multiple data (SIMD) circuits 403, load/store circuits 405, branch/jump circuits 407, and/or Floating-point unit (FPU) circuits 409. ALU circuits 401 perform integer arithmetic and/or Boolean operations. Vector/SIMD circuits 403 perform vector/SIMD operations on packed data (such as SIMD/vector registers). Load/store circuits 405 execute load and store instructions to load data from memory into registers or store from registers to memory. Load/store circuits 405 may also generate addresses. Branch/jump circuits 407 cause a branch or jump to a memory address depending on the instruction. FPU circuits 409 perform floating-point arithmetic. The width of the execution unit(s) circuitry 362 varies depending upon the example and can range from 16-bit to 1,024-bit, for example. In some examples, two or more smaller execution units are logically combined to form a larger execution unit (e.g., two 128-bit execution units are logically combined to form a 256-bit execution unit).

### Exemplary Register Architecture

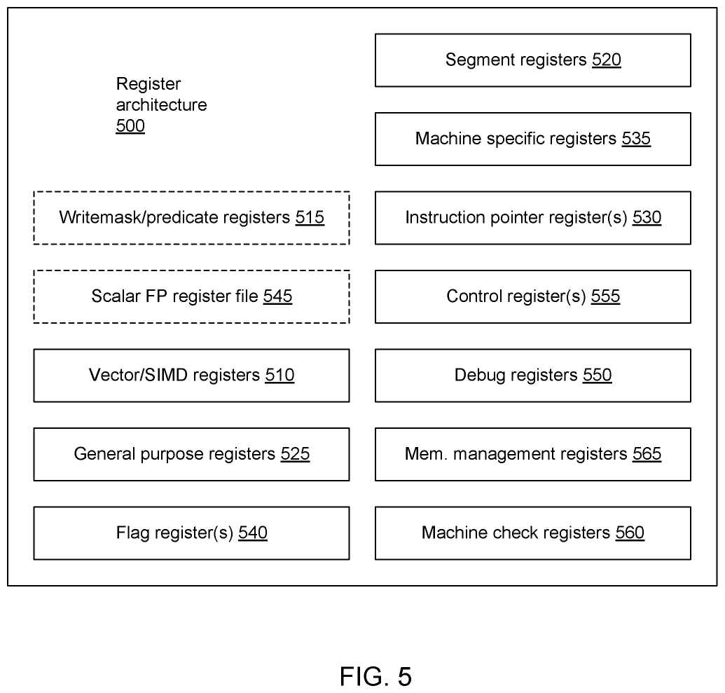

FIG. 5 is a block diagram of a register architecture 500 according to some examples. As illustrated, the register architecture 500 includes vector/SIMD registers 510 that vary from 128-bit to 1,024 bits width. In some examples, the vector/SIMD registers 510 are physically 512-bits and, depending upon the mapping, only some of the lower bits are used. For example, in some examples, the vector/SIMD registers 510 are ZMM registers which are 512 bits: the lower 256 bits are used for YMM registers and the lower 128 bits are used for XMM registers. As such, there is an overlay of registers. In some examples, a vector length field selects between a maximum length and one or more other shorter lengths, where each such shorter length is half the length of the preceding length. Scalar operations are operations performed on the lowest order data element position in a ZMM/YMM/XMM register; the higher order data element positions are either left the same as they were prior to the instruction or zeroed depending on the example.

In some examples, the register architecture 500 includes writemask/predicate registers 515. For example, in some examples, there are 8 writemask/predicate registers (sometimes called k0 through k7) that are each 16-bit, 32-bit, 64-bit, or 128-bit in size. Writemask/predicate registers 515 may allow for merging (e.g., allowing any set of elements in the destination to be protected from updates during the execution of any operation) and/or zeroing (e.g., zeroing vector masks allow any set of elements in the destination to be zeroed during the execution of any operation). In some examples, each data element position in a given writemask/predicate register 515 corresponds to a data element position of the destination. In other examples, the writemask/predicate registers 515 are scalable and consists of a set number of enable bits for a given vector element (e.g., 8 enable bits per 64-bit vector element).

The register architecture 500 includes a plurality of general-purpose registers 525. These registers may be 16-bit, 32-bit, 64-bit, etc. and can be used for scalar operations. In some examples, these registers are referenced by the names RAX, RBX, RCX, RDX, RBP, RSI, RDI, RESPECT, and R8 through R15.

In some examples, the register architecture 500 includes scalar floating-point (FP) register 545 which is used for scalar floating-point operations on 32/64/80-bit floating-point data using the x87 instruction set architecture extension or as MMX registers to perform operations on 64-bit packed integer data, as well as to hold operands for some operations performed between the MMX and XMM registers.

One or more flag registers 540 (e.g., EFLAGS, RFLAGS, etc.) store status and control information for arithmetic, compare, and system operations. For example, the one or more flag registers 540 may store condition code information such as carry, parity, auxiliary carry, zero, sign, and overflow. In some examples, the one or more flag registers 540 are called program status and control registers.

Segment registers 520 contain segment points for use in accessing memory. In some examples, these registers are referenced by the names CS, DS, SS, ES, FS, and GS.

Machine specific registers (MSRs) 535 control and report on processor performance. Most MSRs 535 handle system-related functions and are not accessible to an application program. Machine check registers 560 consist of control, status, and error reporting MSRs that are used to detect and report on hardware errors.

One or more instruction pointer register(s) 530 store an instruction pointer value. Control register(s) 555 (e.g., CR0-CR4) determine the operating mode of a processor (e.g., processor 170, 180, 138, 115, and/or 200) and the characteristics of a currently executing task. Debug registers 550 control and allow for the monitoring of a processor or core's debugging operations.

Memory (mem) management registers 565 specify the locations of data structures used in protected mode memory management. These registers may include a GDTR, IDRT, task register, and a LDTR register.

Alternative examples may use wider or narrower registers. Additionally, alternative examples may use more, less, or different register files and registers. The register architecture 500 may, for example, be used in physical register file(s) circuitry 358.

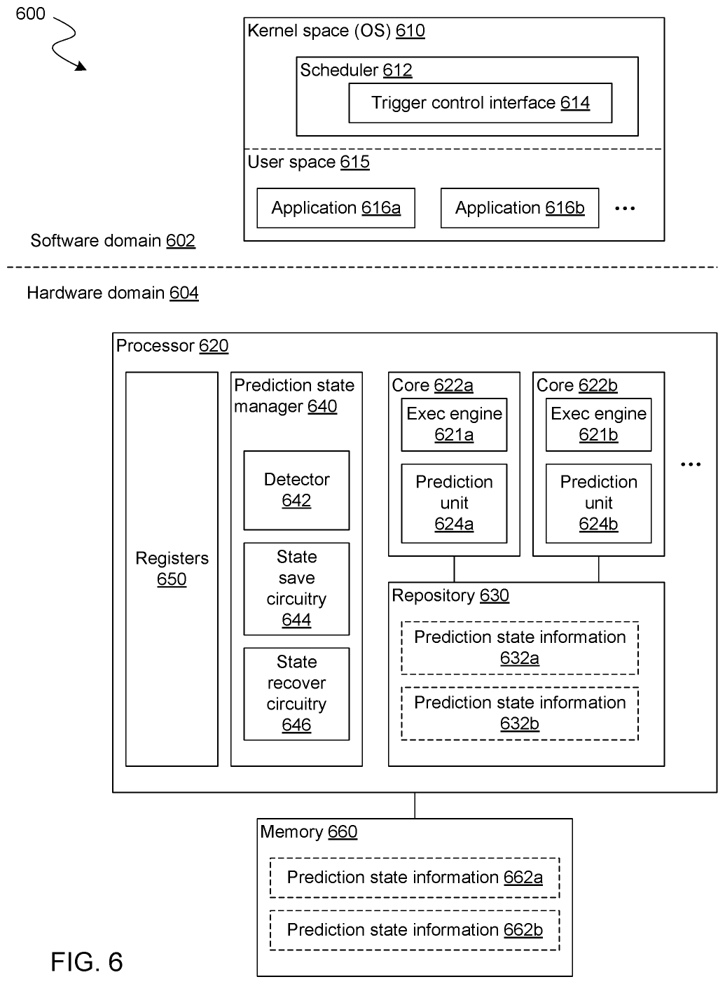

FIG. 6 shows a system 600 which provides access to prediction state information according to an embodiment. System 600 illustrates features of one example embodiment wherein circuitry of a processor is operable to automatically save a microarchitectural state of prediction circuitry based on an indication of a switch from a context which resulted in the generation of said microarchitectural state.

As shown in FIG. 6, system 600 comprises a hardware domain 604 which includes any of various circuits and/or other resources which are suitable to execute one or more processes of a software domain 602. By way of illustration and not limitation, an operating system (OS) 610 is one example of a process which is provided with a kernel space of software domain 602. The OS 610 facilitates the execution of any of various other processes—such as the illustrative applications 616a, 616b shown—in a user space 615 of software domain 602.

In the example embodiment shown, hardware domain 604 comprises a processor 620, and a memory 660 which, for example, is to function as a main memory for processes executed with processor 620. In various embodiments, processor 620 comprises multiple cores (such as the illustrative cores 622a, 622b shown) which are to variously execute one or more processes at a given time—e.g., wherein a given one of cores 622a, 622b correspond functionally processor core 390. In one such embodiment, cores 622a, 622b comprise respective prediction units 624a, 624b which, for example, each provide functionality such as that of branch prediction circuitry 332. In another embodiment, processor 620 is a single core processor which (for example) omits core 622b.

In some embodiments, software domain 602 and/or hardware domain 604 provide functionality to variously switch one or more cores of processor 620 each between the execution of a respective first process and the execution of a respective second process. By way of illustration and not limitation, a scheduler 612 of OS 610 facilitates time slicing functionality which signals a given one of core 622a, 622b to successively switch between executing different ones of applications 616a, 616b (and/or other such software resources).

For example, at the expiration of a given time slice, scheduler 612 signals a “context switch” wherein a first architectural state of core 622a (for example) is replaced with a second architectural state—e.g., the first architectural state having been generated in the execution of an instance of application 616a, and the second architectural state having been generated in the execution of an instance of application 616b. In various embodiments, such functionality of scheduler 612 includes one or more operations which are adapted from conventional time slicing techniques. The particulars of such conventional time slicing techniques are not limiting on some embodiments, and are not detailed herein to avoid obscuring certain features of various embodiments.

Some embodiments variously supplement the saving and/or recovering of architectural state—e.g., as part of an otherwise conventional context switch—with the automatic saving and/or recovering of microarchitectural prediction state information. For example, processor 620 further comprises, is coupled to access, or otherwise operates with, a prediction state manager 640 comprising a programmable gate array (PGA), an application specific integrated circuit (ASIC), a state machine and/or other suitable circuitry which is configured to directly or indirectly manage the movement of state information between prediction circuitry of a core, and a repository which is external to said core. Such a repository is local to processor 620 or, alternatively, is located at memory 660 (or some other suitable resource which is external to processor 620). Although prediction state manager 640 is shown as being external to the cores 622a, 622b of processor 620, in other embodiments, functionality of prediction state manager 640 is instead implemented within each of one or more such processor cores.

In the example embodiment shown, a detector 642 of prediction state manager 640 comprises circuitry which is coupled to receive, snoop or otherwise detect a one or more signals—e.g., from scheduler 612—which specify or otherwise indicate that a context switch has been, is being, or is expected to be performed. In an illustrative scenario according to one embodiment, the context switch is to facilitate core 622a stopping (e.g., completing, terminating, or suspending) an execution of an instance of application 616a, and performing (e.g., starting or resuming) an execution of an instance of application 616b. Based on the indication of such a context switch, detector 642 signals state save circuitry 644 of prediction state manager 640 to perform one or more operations which result in some or all of the current state of prediction unit 624a—e.g., comprising some or all of the current prediction information at prediction unit 624a—to be moved from cores 622a to an external repository.

In one such embodiment, memory 660 provides a repository of microarchitectural prediction state information—e.g., wherein some or all of the current state of prediction unit 624a is moved, copied, or otherwise written to memory 660 as prediction state information 662a. In other embodiments, repository 630 provides such a repository—e.g., wherein microarchitectural prediction state information of prediction unit 624a is moved, copied, or otherwise written, to repository 630 as prediction state information 632a. For example, prediction state information 632a is written to a last level cache (LLC) of a hierarchical cache system of processor 620, wherein the LLC makes prediction state information 632a available for later recovery by core 622a and/or by any of one or more other cores (such as core 622b) of processor 620. In another embodiment, repository 630 is a buffer (or other suitable circuit resource) which is dedicated to storing prediction state information.

In some embodiments, the indication of a context switch additionally or alternatively results in a loading of other microarchitectural prediction state information for a different software process—e.g., wherein said other microarchitectural prediction state information was previously saved to the repository from core 622a, core 622b or some other core (if any) of processor 620. By way of illustration and not limitation, detector 642 further signals state recover circuitry 646 of prediction state manager 640 to perform one or more operations which result in prediction state information 662b (for example) being recovered from memory 660 to prediction unit 624a. In an alternative embodiment, state recover circuitry 646 instead recovers prediction state information 632b from repository 630 to prediction unit 624a. In some embodiments, microarchitectural prediction state information—generated based on an execution of a process (such as application 616a) executing in user space 615—is saved to, or recovered from, a repository independent of any instruction of that same process which might specify that such saving or recovery is to be performed. For example, such save and recover activities are triggered and handled automatically by hardware upon a context switch in an “instruction-less” manner, without the need of explicit software instruction.

For example, cores 622a, 622b comprise respective execution engines 621a, 621b to variously execute instructions of software processes (such as applications 616a, application 616b) of user space 615—e.g., wherein execution engines 621a, 621b provide functionality such as that of execution engine unit circuitry 350. Microarchitectural state of cores 622a, 622b changes over time as one or more software processes are executed. For example, based on an execution of instructions with execution engine 621a, prediction unit 624a generates (and for example, updates) prediction information such as branch predictions, branch target predictions, return predictions and/or the like. For example, a branch predictor typical contains one or more branch prediction arrays, the entries of which cache the records from previously executed branches, and are used as a lookup table to make prediction of the branches to be executed. Alternatively or in addition, prediction unit 624b generates (and for example, updates) other prediction information based on an execution of instructions with execution engine 621b. At a given time, a microarchitectural state of core 622a comprises some or all of the prediction information which is currently at prediction unit 624a—e.g., wherein a microarchitectural state of core 622b comprises some or all of the prediction information which is currently at prediction unit 624b.

In some embodiments, a context switch is to transition a processor core from suspending execution of a first software process to initiating execution of a second software process—e.g., wherein execution of application 616a by core 622a is suspended so that execution of application 616b by core 622b can commence for the first time. In one such embodiment, there is no previously-generated microarchitectural prediction state information for the second software process. Accordingly, such a context switch saves prediction state information for the first software process, but omits the recovery of any prediction state information for the newly initiated second software process.

Although some embodiments are not limited in this regard, system 600 further provides functionality to selectively enable or disable the automatic saving or recovering of prediction state information based on an indication of a context switch. By way of illustration and not limitation, scheduler 612 comprises, or otherwise accommodates operation with, a software interface-such as the illustrative trigger control interface 614—which accesses a mode register (e.g., one of the registers 650 shown) of processor 620. For example, access to such a mode register via trigger control interface 614 enables a BIOS, a user or other suitable agent to set a value of an operational parameter to enable prediction state manager 640 to respond to an indication of a context switch by saving and/or recovering prediction state information. Additionally or alternatively, such an agent is able to set a different value of said operational parameter—e.g., to disable prediction state manager 640 from responding to an indication of a context switch by saving and/or recovering prediction state information. In another embodiment, system 600 omits functionality such as that of trigger control interface 614—e.g., wherein functionality of prediction state manager 640 is always enabled.

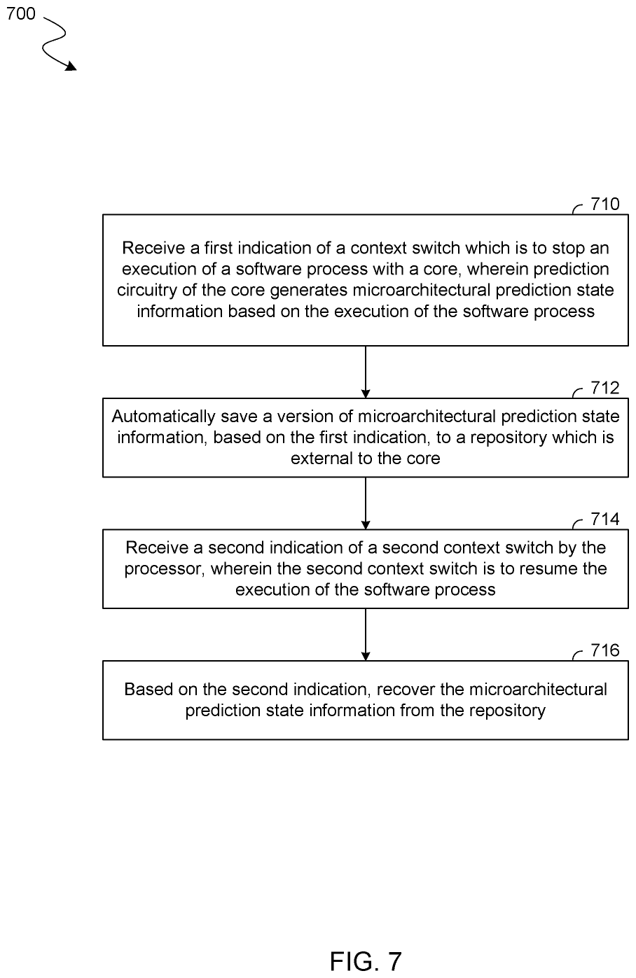

FIG. 7 shows a method 700 for managing prediction state information according to an embodiment. The method 700 illustrates one example of an embodiment wherein microarchitectural state of a processor cores prediction circuitry is automatically saved or recovered based on an indication of a context switch. Operations such as those of method 700 are performed with any of various combinations of suitable hardware (e.g., circuitry), firmware and/or executing software which, for example, provide some or all of the functionality of system 600.

As shown in FIG. 7, method 700 comprises (at 710) receiving a first indication of a context switch by a processor, wherein the context switch is to stop an execution of a software process with a core of the processor. In an embodiment, prediction circuitry of the core generates microarchitectural prediction state information based on the execution of the software process. In one such embodiment, receiving the indication comprises receiving, snooping or otherwise detecting a signal from a scheduler process in software, wherein the scheduler process facilitates time slicing functionality of an operating system. In various embodiments, the prediction circuitry comprises (for example) one of a conditional branch predictor, an indirect branch predictor, a branch target buffer, or a return predictor.

Based on the first indication which is received at 710, method 700 (at 712) automatically saves a version of the microarchitectural prediction state information to a repository which is external to the core. In an embodiment, the processor comprises the repository—e.g., wherein a last level cache of the processor comprises the repository, or wherein the repository is a buffer resource which is dedicated to buffering only prediction state information.

In an alternative embodiment, the repository is provided at a portion of a random access memory which is coupled to the processor—e.g., wherein different respective IC chips comprise the processor and the random access memory. In one such embodiment, the portion of the random access memory is defined with one or more range registers of the processor—e.g., wherein the one or more range registers facilitate a security of access to the repository.

In an embodiment, the automatic saving at 712 comprises encrypting the microarchitectural prediction state information before the resulting encrypted state information is written to the repository. Alternatively or in addition, the automatic saving at 712 comprises (for example) providing to the repository tag information which identifies the software process.

In some embodiments, the automatic saving at 712 is performed based on an operational mode of the processor, wherein the operational mode (e.g., defined by a setting of one or more mode registers of the processor) enables the processor to automatically save and/or recover microarchitectural state in response to the detection of a context switch. By way of illustration and not limitation, the operational mode is one of multiple selectable operational modes—e.g., wherein an alternative one of the multiple operational modes is to disable such automatic saving and/or recovery of microarchitectural prediction state.

Although some embodiments are not limited in this regard, method 700 comprises additional operations to automatically recover prediction state information such as that the microarchitectural prediction state information. For example, method 700 further comprises (at 714) receiving a second indication of a second context switch by the processor, wherein the second context switch is to resume the execution of the software process. In an embodiment, the second indication includes or is otherwise based on a signal, from a scheduler process, which specifies or otherwise indicates that an upcoming time slice is allocated to the software process.

Based on the second indication which is received at 714, method 700 (at 716) recovers the microarchitectural prediction state information from the repository. In one such embodiment, recovering at 716 is based on tag information which identifies the saved version of the microarchitectural prediction state information as being associated with the software process. Alternatively or in addition, the recovering at 716 comprises (for example) performing a decryption operation to generate an unencrypted version of the microarchitectural prediction state information. In one example, embodiment, the second context switch is to resume the execution of the software process with a second core of the processor—e.g., wherein, based on the second indication, the microarchitectural prediction state information is recovered to second prediction circuitry of the second core.

In another example embodiment, the second context switch is to resume the execution of the software process with the same core of the processor—e.g., wherein, based on the second indication, the microarchitectural prediction state information is recovered to the same prediction circuitry which generated the microarchitectural prediction state information. In an illustrative scenario according to one embodiment, the core further performs an execution of a second software process while the version of the microarchitectural prediction state information is at the repository. For example, the prediction circuitry of the core further generates second microarchitectural prediction state information based on the execution of the second software process. In one such embodiment, the second context switch is further to stop the execution of the software process with the core—e.g., wherein, based on the second indication, a version of second microarchitectural prediction state information is automatically saved to the repository.

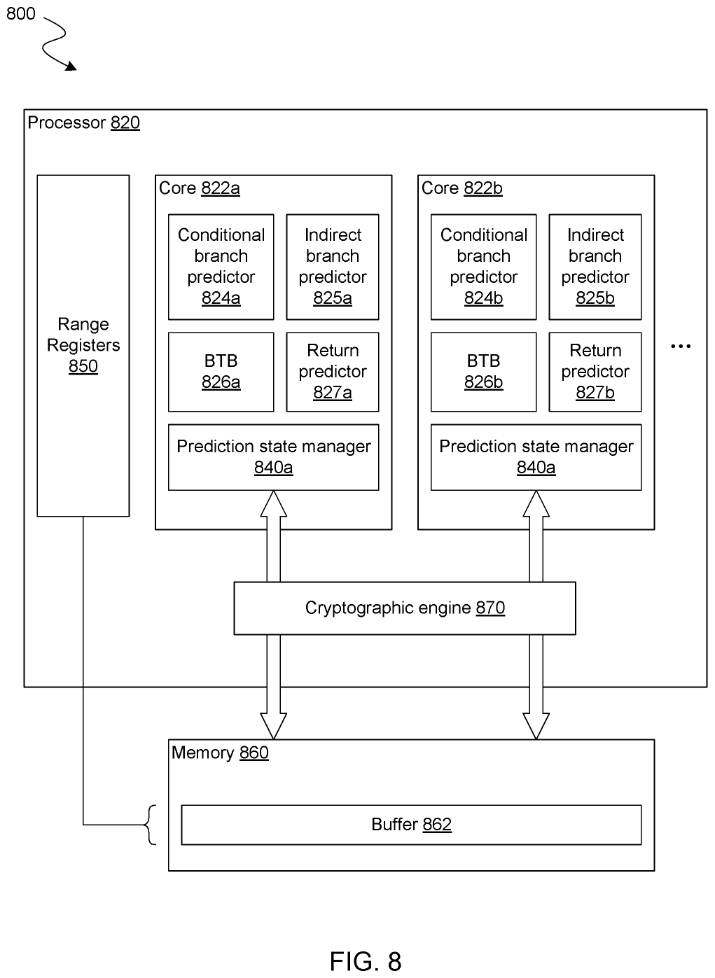

FIG. 8 shows a system 800 which automatically saves and protects prediction state information according to an embodiment. System 800 illustrates features of one example embodiment wherein a state of prediction circuitry is saved, in an encrypted form, to a main memory (or other suitable resource which is external to a processor). In some embodiments, system 800 provides functionality such as that of system 600—e.g., wherein operations of method 700 are performed with some or all of system 800.

As shown in FIG. 8, system 800 comprises a processor 820 and a memory 860 which, for example, provide functionality of processor 620, and memory 660 (respectively). Processor 820 comprises one or more processor cores (e.g., including the illustrative cores 822a, 822b shown)—e.g., wherein respective prediction state managers 840a, 840b of cores 822a, 822b each provide functionally such as that of prediction state manager 640. In some embodiments, processor 820 further comprises range registers 850 which provide functionality such as that of registers 650.

In the example embodiment shown, functionality such as that of prediction unit 624a is provided (for example) with some or all of a conditional branch predictor 824a, an indirect branch predictor 825a, a branch target buffer (BTB) 826a, and a return predictor 827a of core 822a. Alternatively, or in addition, core 822b similarly comprises some or all of a conditional branch predictor 824b, an indirect branch predictor 825b, a branch target buffer (BTB) 826b, and a return predictor 827b. In one such embodiment, conditional branch predictor 824a comprises circuitry to predict the outcome of an evaluation to identify the presence or absence of a given condition in the execution of a branch instruction. Alternatively, or in addition, indirect branch predictor 825a comprises circuitry to predict an address of an instruction which is to be jumped to, based on an execution of an indirect branch instruction. Alternatively, or in addition, BTB 826a comprises circuitry to predict what the target of a given branch will be—e.g., wherein return predictor 827a comprises circuitry to predict (for example) an address that is to be pushed off of a return stack. In various embodiments, core 822a and/or core 822b comprise any of various additional or alternative types of prediction circuitry, which are not limiting on other embodiments.

In an embodiment, one or more of range registers 850 are to be programmed or otherwise configured with address information that identifies a range, in memory 860, which is to function as a buffer 862 for prediction state information. Range registers 850 thus facilitate the protection of such prediction state information by limiting access to buffer 862. In some embodiments, such configuration of range registers 850 includes one or more operations which (for example) are adapted from conventional memory management techniques.

In an illustrative scenario according to one embodiment, prediction state manager 840a provides functionality to detect that a context switch of core 822a has been, is being, or is expected to be performed. Based on such detection, prediction state manager 840a saves to buffer 862 at least some version of a current prediction state of one or more of conditional branch predictor 824a, indirect branch predictor 825a, BTB 826a, and return predictor 827a. In one such embodiment, the current prediction state comprises microarchitectural prediction state information which is provided to a cryptographic engine 870 of processor 820. Cryptographic engine 870 performs encryption operations to generate an encrypted version of the microarchitectural prediction state information, which is then saved to buffer 862.

By way of illustration and not limitation, cryptographic engine 870 performs one or more operations adapted (for example) from cryptographic techniques such as those identified by the Advanced Encryption Standard, published in 2001 by the U.S. National Institute of Standards and Technology (NIST). However, in certain embodiments, cryptographic engine 870 performs any of various additional or alternative types of encryption operations, which are not limiting on some other embodiments.

In one such scenario, detection of the context switch further results in prediction state manager 840a recovering—to one or more of conditional branch predictor 824a, indirect branch predictor 825a, BTB 826a, and return predictor 827a—other respective prediction state information which is available from buffer 862. By way of illustration and not limitation, cryptographic engine 870 further performs one or more decryption operations to convert previously-saved (and encrypted) prediction state information into an unencrypted form prior to recovering a previous prediction state of core 822a.

Similarly, prediction state manager 840b provides functionality to detect a context switch of core 822b. Based on such detection, prediction state manager 840b saves to buffer 862 at least some version of a current state of conditional branch predictor 824b, indirect branch predictor 825b, BTB 826b, and/or return predictor 827b. In one such embodiment, microarchitectural prediction state information is provided from core 822b to cryptographic engine 870, which performs encryption operations to generate an encrypted version of the microarchitectural prediction state information for saving to buffer 862. In one such scenario, detection of the context switch of core 822b further results in an encrypted version of other microarchitectural prediction state information being retrieved from buffer 862, decrypted by cryptographic engine 870, and variously provided to one or more of conditional branch predictor 824b, indirect branch predictor 825b, BTB 826b, and return predictor 827b.

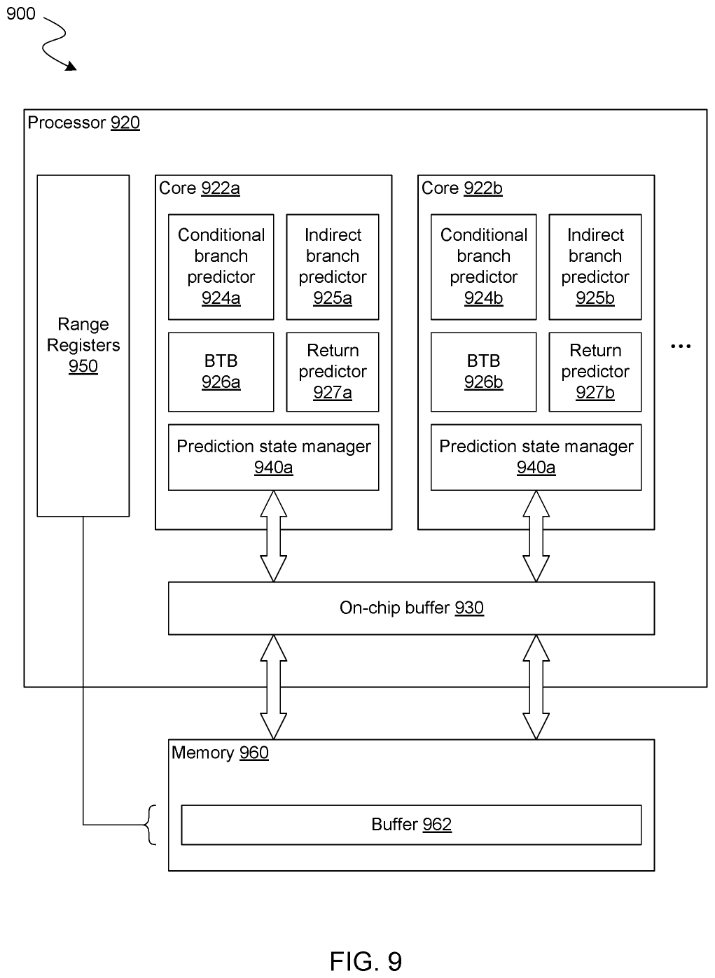

FIG. 9 shows a system 900 which triggers a buffering of microarchitectural prediction state information according to an embodiment. System 900 illustrates features of one example embodiment which provides multi-level buffering in the transfer of microarchitectural prediction state information to and/or from a processor core. In some embodiments, system 900 provides functionality such as that of system 600 or system 800—e.g., wherein operations of method 700 are performed with some or all of system 900.

As shown in FIG. 9, system 900 comprises a processor 920, and a random access memory 960 which, for example, correspond functionally to processor 820 and memory 860 (respectively). Processor 920 and memory 960 are on different respective integrated circuit (IC) chips, for example. Processor 920 comprises one or more processor cores—e.g., wherein respective prediction state managers 940a, 940b of the illustrative cores 922a, 922b variously provides functionality of prediction state manager 840. In some embodiments, processor 920 further comprises range registers 950 which provide functionality such as that of range registers 850. In the example embodiment shown, prediction circuitry of core 922 comprises (for example) some or all of a conditional branch predictor 924a, an indirect branch predictor 925a, a BTB 926a, and a return predictor 927a of core 922a. Alternatively or in addition, core 922b similarly comprises some or all of a conditional branch predictor 924b, an indirect branch predictor 925b, a BTB 926b, and a return predictor 927b.

In the example embodiment shown, one or more of range registers 950 are programmed or otherwise configured with address information that identifies a range, in memory 960, which is to function as a buffer 962 for prediction state information. To facilitate context switches by processor 920, prediction state managers 940a, 940b provide functionality to variously move prediction state information between cores 922a, 922b (respectively) and buffer 962—e.g., via an on-chip buffer 930 of processor 920. In one such embodiment, on-chip buffer 930 is to serve as an eviction buffer (or any of various other suitable types of intermediary repositories) for buffer 962.

By way of illustration and not limitation, prediction state manager 940a facilitates a first context switch with operations to save first microarchitectural prediction state information which is generated at core 922a based on the execution of a first instance of a first application. In one such embodiment, such first microarchitectural prediction state information—from some or all of conditional branch predictor 924a, indirect branch predictor 925a, BTB 926a, and return predictor 927a—is copied, moved or otherwise provided to buffer 962 via on-chip buffer 930.

In one such embodiment, prediction state manager 940a further facilitates a second context switch with other operations to save second microarchitectural prediction state information which is generated at core 922a by the execution of a second instance of a second application. In some embodiments, the first context switch is to recover the second microarchitectural prediction state information to prediction circuitry of core 922a, or (alternatively) the second context switch is to recover the first microarchitectural prediction state information to prediction circuitry of core 922a.

Alternatively or in addition, prediction state manager 940b facilitates a third context switch with other operations to save third microarchitectural prediction state information which is generated at core 922b by the execution of a third instance of a third application. For example, such third microarchitectural prediction state information—from some or all of conditional branch predictor 924b, indirect branch predictor 925b, BTB 926b, and return predictor 927b—is copied, moved or otherwise provided to buffer 962 via on-chip buffer 930.

In one such embodiment, prediction state manager 940b further facilitates a fourth context switch with other operations to save fourth microarchitectural prediction state information which is generated at core 922b by the execution of a fourth instance of a fourth application. In some embodiments, the third context switch is to recover the fourth microarchitectural prediction state information to prediction circuitry of core 922b, or (alternatively) the fourth context switch is to recover the third microarchitectural prediction state information to prediction circuitry of core 922b. In various other embodiments, a given context switch is to recover to one of cores 922a, 922b microarchitectural prediction state information which was previously saved from the other one of cores 922a, 922b.

In some hardware-controlled embodiments, microarchitectural prediction state information is tagged to be associated with one or more data structures and/or other suitable resources—e.g., including a page directory base (such as one provided with a CR3 control register in a x86 architecture)—that are allocated to or otherwise associated with a particular software context. In one such embodiment, a prediction state manager and/or context tagger circuitry is operable to directly or indirectly use software-context-specific information, in any of various suitable data resources which are visible to hardware, to identify a correspondence of prediction state with a software context which generated said prediction state. Such an embodiment thus enables the saving and restoring of only a subset of the current prediction state, for the switching-out context in question—i.e., without requiring the saving and/or restoring of a full snapshot of all prediction context.

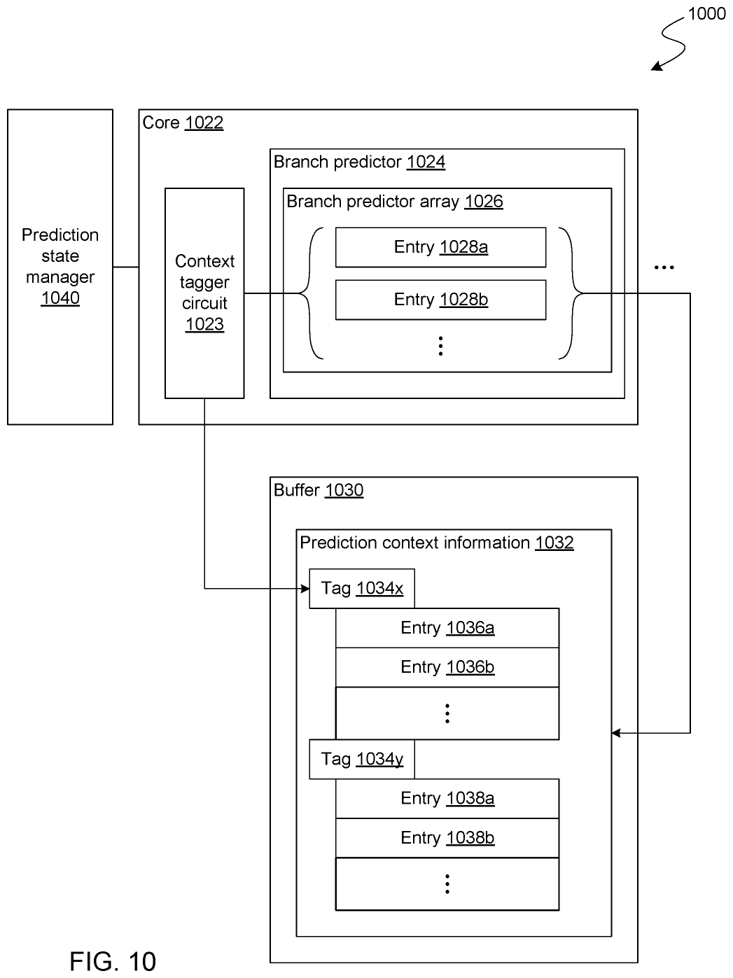

FIG. 10 shows a device 1000 which manages access to prediction state information according to an embodiment. Device 1000 illustrates features of one example embodiment which is operable to provide tag information for associating a prediction state information with a particular software context. In some embodiments, device 1000 provides functionality such as that of one of systems 600, 800, 900—e.g., wherein operations of method 700 are performed with some or all of device 1000.

As shown in FIG. 10, device 1000 comprises a core 1022, and a buffer 1030 which is to function as a repository of microarchitectural prediction state information. In one such embodiment, core 1022 comprises functionally of one of cores 622a, 622b—e.g., wherein buffer 1030 is provided with repository 630 or memory 660 (for example). In an embodiment, device 1000 further comprises a prediction state manager 1040 which, for example, provides functionality of one of prediction state managers 640, 840a, 840b, 940a, 940b.

In the illustrative embodiment shown, prediction circuitry of core 1022 comprises, for example, a branch predictor 1024, wherein various branch predictions are variously provided each in a different respective entry (e.g., one of the entries 1028a, 1028b, . . . shown) of a branch predictor array 1026. In some embodiments, the generation of such branch predictions, and/or other suitable microarchitectural prediction state information, includes operations which are adapted from conventional processor techniques.

In the example embodiment shown, prediction state manager 1040 receives, snoops or otherwise detects a one or more signals—e.g., from a scheduler routine of an OS-which specify or otherwise indicate that a context switch has been, is being, or is expected to be performed. In an illustrative scenario according to one embodiment, the context switch is to facilitate core 1022 stopping an execution of an instance of a first application, and performing an execution of an instance of a second application. Based on the indication of such a context switch, prediction state manager 1040 performs operations to save the current prediction information in entries 1028a, 1028b, etc. of branch predictor array 1026.

For example, such prediction information is copied, moved or otherwise provided as entries 1036a, 1036b, etc. of saved prediction context information 1032 in buffer 1030. In one such embodiment, core 1022 further comprises a context tagger circuit 1023 which generates tag information-such as the illustrative tag 1034x shown—to identify entries 1036a, 1036b, etc. as corresponding to the first application. The tag 1034x facilitates the subsequent recovery of entries 1036a, 1036b, etc. to core 1022—or to another core of device 1000 (if any)—for a resumed execution of the first application. By way of illustration and not limitation, tag 1034x specifies or otherwise indicates an identifier of an execution thread which is to implement an instance of the first application. Alternatively or in addition, tag 1034x identifies (for example) some or all of a total number of the entries 1036a, 1036b, etc., the size of an individual one such entry 1036, a type of prediction information which is provided by a given one such entry 1036, and/or the like.

In one such embodiment, tag 1034x facilitates a distinguishing between first prediction state information for one software process (and/or for one type of prediction circuit), and second prediction state information for another software process (and/or for a different type of prediction circuit). For example, context tagger circuit 1023 additionally or alternatively provides tag information (such as the illustrative tag 1034y shown) to identify entries 1038a, 1038b, etc. of other prediction information as corresponding to the second application. Similar to tag 1034x, the tag 1034y facilitates the subsequent recovery of entries 1038a, 1038b, etc. to core 1022—or to another core of device 1000 (if any)—for a resumed execution of some other application, for example. By way of illustration and not limitation, tag 1034y specifies or otherwise indicates an identifier of an execution thread which is to implement an instance of the second application.

In the example embodiment shown, tagging information such as that illustrated by tag 1034x is common to each of multiple entries of saved predication state information (e.g., each of entries 1036a, 1036b, etc.). In an alternate embodiment, each of such multiple entries is individually tagged with a thread identifier and/or other suitable tagging information. For example, individual instances of tag information are provided each for a respective entry of prediction context information 1032 (and, in some embodiments, each for a respective entry of branch predictor array 1026). Additionally or alternatively, the context tagger circuit 1023 is able to selectively tag some or all entries in branch predictor array 1026 to associate said entries with a particular software context (e.g., to enable the saving and subsequent restoring of only the entries that belong to that software context). Although tags 1034x, 1034y are shown as being provided by context tagger circuit 1023, some or all such tagging information is additionally or alternatively provided, in other embodiments, by an OS scheduler or other suitable software resource.

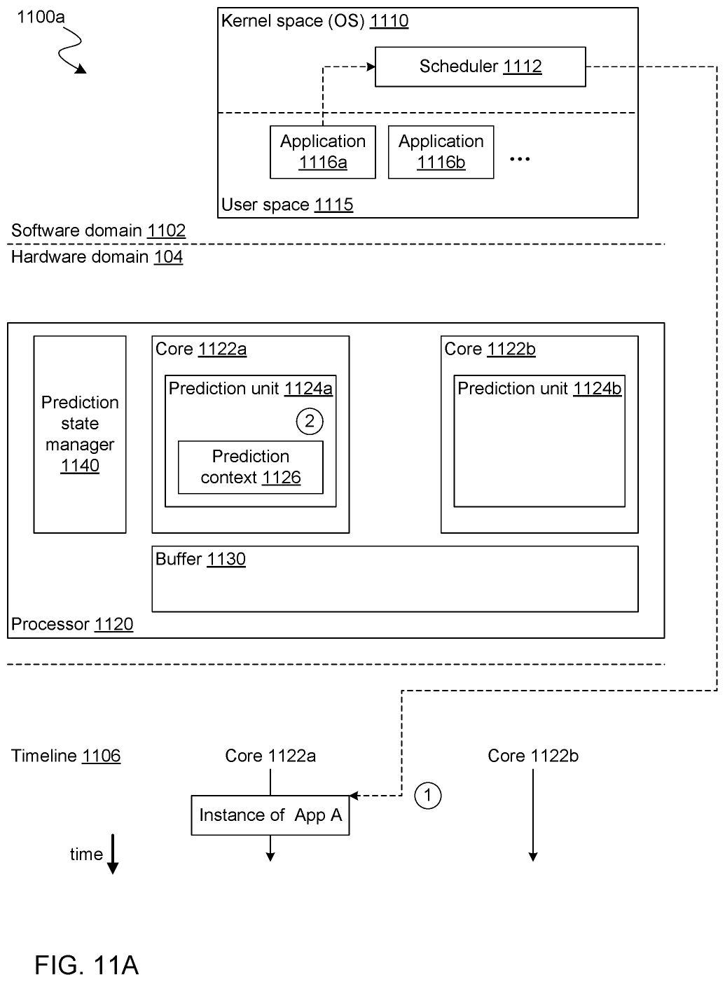

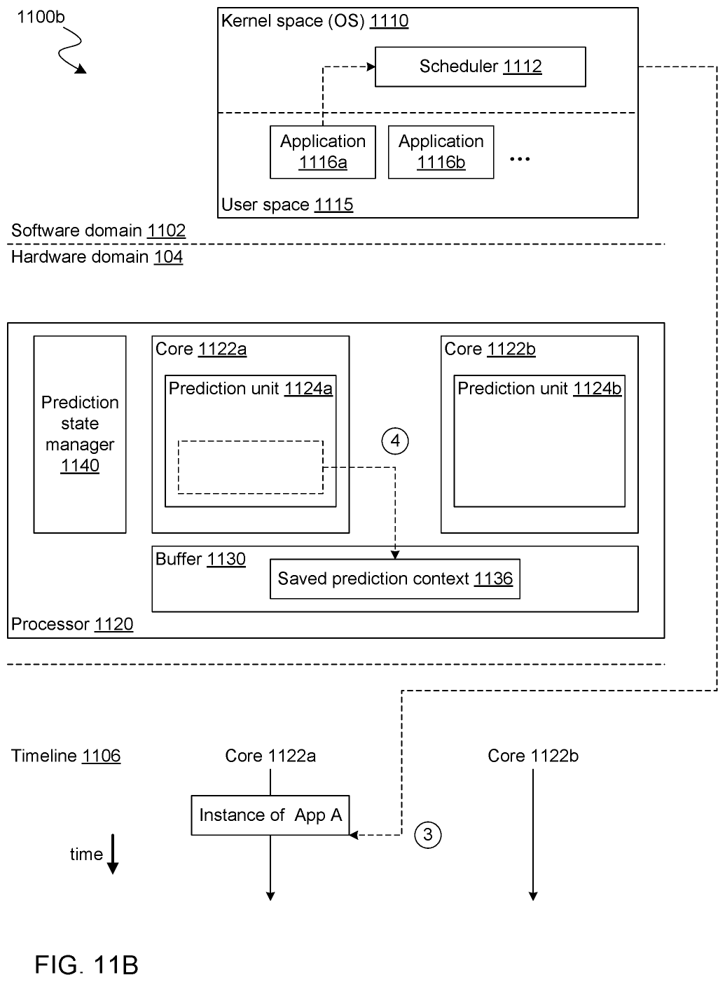

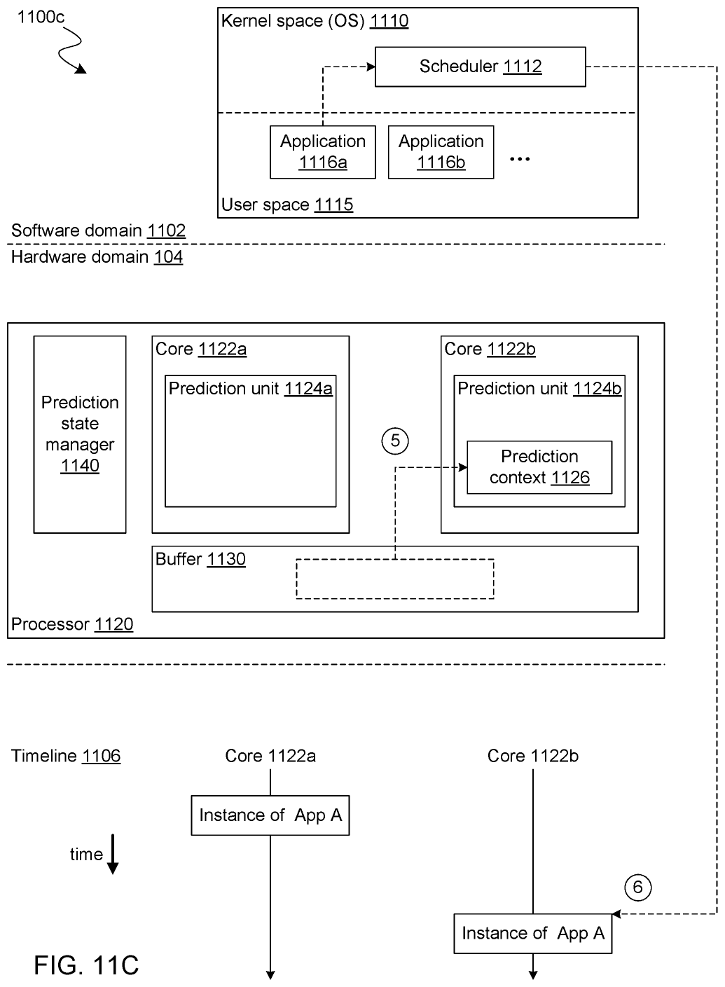

FIGS. 11A-11C are hybrid block and timing diagrams showing various operations performed each during a respective one of multiple stages 1100a-c of operations which share prediction state information among processor cores according to an embodiment. In various embodiments, operations such as those illustrated with stages 1100a-c are performed with circuitry such as that of one of systems 600, 800, 900 or of device 1000—e.g., wherein method 700 includes some or all such operations.

As shown in FIG. 11A, a system comprises a hardware domain 1104 which executes one or more processes of a software domain 1102. By way of illustration and not limitation, an OS 1110 executes in a kernel space of software domain 1102, wherein any of various other processes—such as the illustrative applications 1116a, 1116b shown—execute in a user space 1115 of software domain 1102. A timeline 1106 shows operations performed with hardware domain 1104 over a period of time during the provisioning of software domain 1102.

In the example embodiment shown, hardware domain 1104 comprises a processor 1120 which (for example) provides functionality such as that of processor 620. Processor 1120 comprises multiple cores (such as the illustrative cores 1122a, 1122b shown) which are to variously execute one or more processes at a given time—e.g., wherein a given one of cores 1122a, 1122b correspond functionally processor core 390. In one such embodiment, cores 1122a, 1122b comprise respective prediction units 1124a, 1124b which, for example, provide functionality of prediction units 624a, 624b. In one example embodiment, a scheduler 1112 of OS 1110 facilitates the scheduling of different software processes for execution each by a respective one of cores 1122a, 1122b. For example, scheduler 1112 enables time slicing functionality by which application 1116a (for example) is variously executed by each of core 1122a, 1122b.

In an illustrative scenario according to one embodiment, scheduler 1112 initiates, resumes or otherwise starts an execution of an instance of application 1116a on core 1122a (as indicated by the label “1” shown at stage 1100a). During the execution of application 1116a, prediction unit 1124a of core 1122a generates prediction context 1126 of application 1116a (as indicated by the label “2” shown at stage 1100a).

Referring now to FIG. 11B, scheduler 1112 subsequently suspends, interrupts or otherwise stops the execution of application 1116a on core 1122a (as indicated by the label “3”)—e.g., based on an expiration of a time slice which is allocated to application 1116a. Based on an indication of the switch of core 1122a away from the context of application 1116a, a prediction state manager 1140 of processor 1120 performs operations to save some or all of the current prediction context 1126 in a buffer 1130 of processor 1120 (or alternatively, in a main memory or other suitable resource which is coupled to processor 1120). For example, prediction context 1126 is copied, moved or otherwise provided to buffer 1130 as saved prediction context 1136 (as indicated by the label “4” shown at stage 1100b). In some embodiments, the saving and/or recovering of prediction context 1126 is triggered by scheduler 1112 through a software interface or, for example, using any of various suitable hardware mechanisms.

Referring now to FIG. 11C, the saved prediction context 1136 of application 1116a is subsequently recovered to one of the cores 1122a, 1122b. By way of illustration and not limitation, prediction state manager 1140 performs operations (e.g., responsive to scheduler 1112) for recovering the saved prediction context 1136 to facilitate further execution of application 1116a with core 1122b. In the example embodiment shown, prediction unit 1124b of core 1122b receives the prediction context 1126 from buffer 1130 (as indicated by the label “5” shown at stage 1100c). Subsequently, (as indicated by the label “6” shown at stage 1100c) scheduler 1112 resumes or otherwise executes the same instance of application 1116a on core 1122b.

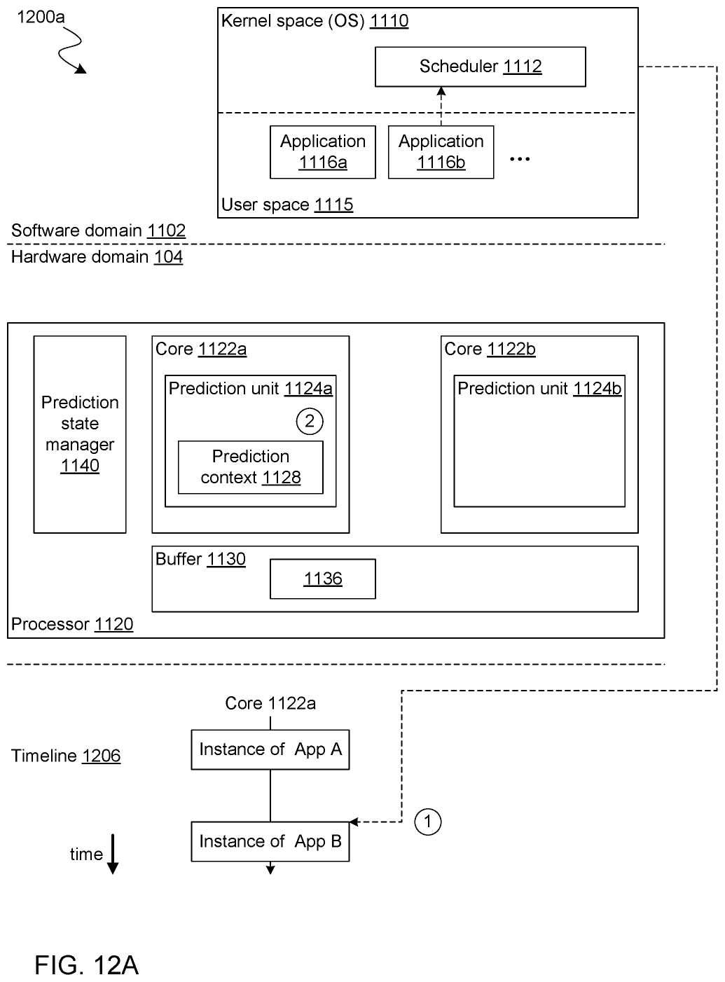

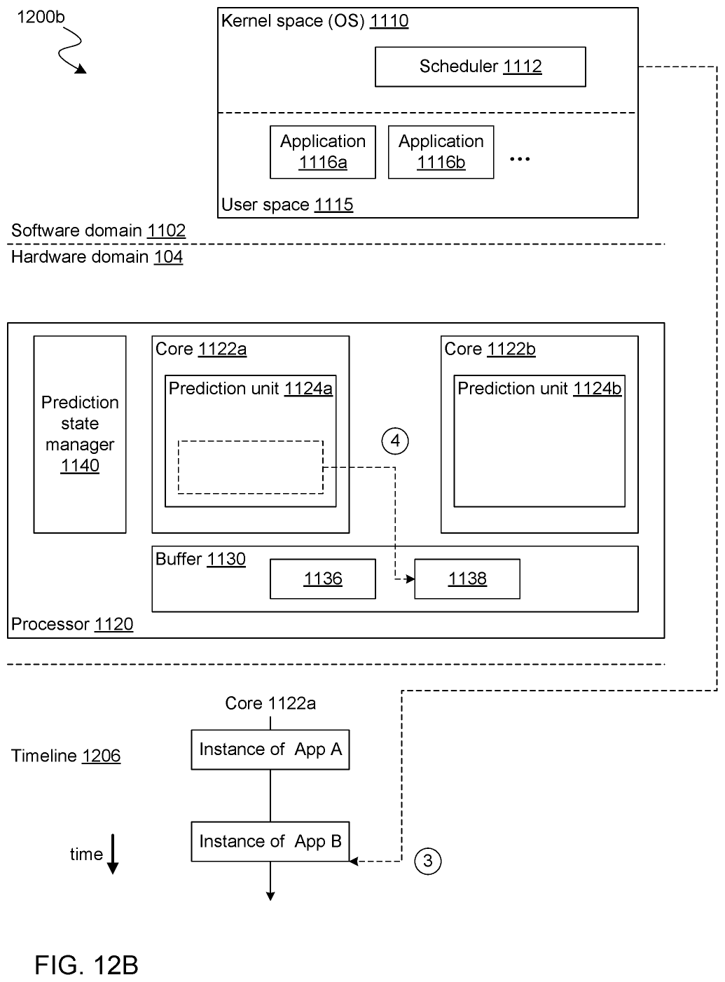

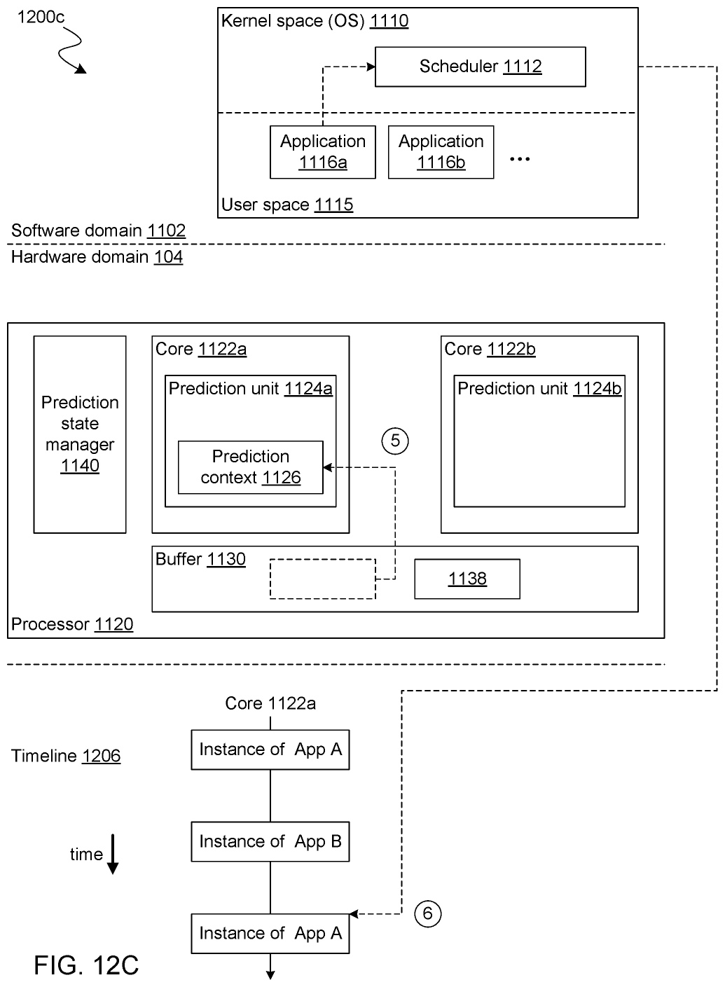

FIGS. 12A-12C are hybrid block and timing diagrams showing various operations performed each during a respective one of multiple stages 1200a-c of operations which save and recover prediction state information according to an embodiment. The operations illustrated with stages 1200a-c represent an alternative scenario to that which is illustrated with stages 1100a-c. More particularly, stages 1200a-c represent an alternative to operations which, in some embodiments, take place after stage 1100b. A timeline 1206 shows operations performed with hardware domain 1104 over a period of time during the provisioning of software domain 1102.

As shown in FIG. 12A, scheduler 1112 initiates, resumes or otherwise starts an execution of an instance of application 1116b on core 1122a (as indicated by the label “1” shown at stage 1200a). This execution of application 1116b is performed, for example, after prediction context 1126 was provided to buffer 1130 as saved prediction context 1136. During the execution of application 1116b, prediction unit 1124a of core 1122a generates prediction context 1128 of application 1116b (as indicated by the label “2” shown at stage 1200a).

Referring now to FIG. 12B, scheduler 1112 subsequently stops the execution of application 1116b on core 1122a (as indicated by the label “3”)—e.g., based on an expiration of a time slice which is allocated to application 1116b. Based on an indication of the switch of core 1122a away from the context of application 1116b, prediction state manager 1140 performs operations to save some or all of the current prediction context 1128 in buffer 1130. For example, prediction context 1128 is provided to buffer 1130 as saved prediction context 1138 (as indicated by the label “4” shown at stage 1200b).

Referring now to FIG. 12C, the saved prediction context 1136 of application 1116a is subsequently recovered to core 1122a after buffer 1130 has received the saved prediction context 1138 for application 1116b. For example, prediction state manager 1140 performs operations (e.g., responsive to scheduler 1112) for recovering the saved prediction context 1136 to resume execution of application 1116a with core 1122a. In the example embodiment shown, prediction unit 1124a receives the prediction context 1126 from buffer 1130 (as indicated by the label “5” shown at stage 1200c). Subsequently, (as indicated by the label “6” shown at stage 1100c) scheduler 1112 resumes the same instance of application 1116a on core 1122a.

The description herein includes numerous details to provide a more thorough explanation of the embodiments of the present disclosure. It will be apparent to one skilled in the art, however, that embodiments of the present disclosure may be practiced without these specific details. In other instances, well-known structures and devices are shown in block diagram form, rather than in detail, in order to avoid obscuring embodiments of the present disclosure.

Note that in the corresponding drawings of the embodiments, signals are represented with lines. Some lines may be thicker, to indicate a greater number of constituent signal paths, and/or have arrows at one or more ends, to indicate a direction of information flow. Such indications are not intended to be limiting. Rather, the lines are used in connection with one or more exemplary embodiments to facilitate easier understanding of a circuit or a logical unit. Any represented signal, as dictated by design needs or preferences, may actually comprise one or more signals that may travel in either direction and may be implemented with any suitable type of signal scheme.

Throughout the specification, and in the claims, the term “connected” means a direct connection, such as electrical, mechanical, or magnetic connection between the things that are connected, without any intermediary devices. The term “coupled” means a direct or indirect connection, such as a direct electrical, mechanical, or magnetic connection between the things that are connected or an indirect connection, through one or more passive or active intermediary devices. The term “circuit” or “module” may refer to one or more passive and/or active components that are arranged to cooperate with one another to provide a desired function. The term “signal” may refer to at least one current signal, voltage signal, magnetic signal, or data/clock signal. The meaning of “a,” “an,” and “the” include plural references. The meaning of “in” includes “in” and “on.”

The term “device” may generally refer to an apparatus according to the context of the usage of that term. For example, a device may refer to a stack of layers or structures, a single structure or layer, a connection of various structures having active and/or passive elements, etc. Generally, a device is a three-dimensional structure with a plane along the x-y direction and a height along the z direction of an x-y-z Cartesian coordinate system. The plane of the device may also be the plane of an apparatus which comprises the device.

The term “scaling” generally refers to converting a design (schematic and layout) from one process technology to another process technology and subsequently being reduced in layout area. The term “scaling” generally also refers to downsizing layout and devices within the same technology node. The term “scaling” may also refer to adjusting (e.g., slowing down or speeding up—i.e. scaling down, or scaling up respectively) of a signal frequency relative to another parameter, for example, power supply level.

The terms “substantially,” “close,” “approximately,” “near,” and “about,” generally refer to being within +/−10% of a target value. For example, unless otherwise specified in the explicit context of their use, the terms “substantially equal,” “about equal” and “approximately equal” mean that there is no more than incidental variation between among things so described. In the art, such variation is typically no more than +/−10% of a predetermined target value.

It is to be understood that the terms so used are interchangeable under appropriate circumstances such that the embodiments of the invention described herein are, for example, capable of operation in other orientations than those illustrated or otherwise described herein.

Unless otherwise specified the use of the ordinal adjectives “first,” “second,” and “third,” etc., to describe a common object, merely indicate that different instances of like objects are being referred to and are not intended to imply that the objects so described must be in a given sequence, either temporally, spatially, in ranking or in any other manner.

The terms “left,” “right,” “front,” “back,” “top,” “bottom,” “over,” “under,” and the like in the description and in the claims, if any, are used for descriptive purposes and not necessarily for describing permanent relative positions. For example, the terms “over,” “under,” “front side,” “back side,” “top,” “bottom,” “over,” “under,” and “on” as used herein refer to a relative position of one component, structure, or material with respect to other referenced components, structures or materials within a device, where such physical relationships are noteworthy. These terms are employed herein for descriptive purposes only and predominantly within the context of a device z-axis and therefore may be relative to an orientation of a device. Hence, a first material “over” a second material in the context of a figure provided herein may also be “under” the second material if the device is oriented upside-down relative to the context of the figure provided. In the context of materials, one material disposed over or under another may be directly in contact or may have one or more intervening materials. Moreover, one material disposed between two materials may be directly in contact with the two layers or may have one or more intervening layers. In contrast, a first material “on” a second material is in direct contact with that second material. Similar distinctions are to be made in the context of component assemblies.

The term “between” may be employed in the context of the z-axis, x-axis or y-axis of a device. A material that is between two other materials may be in contact with one or both of those materials, or it may be separated from both of the other two materials by one or more intervening materials. A material “between” two other materials may therefore be in contact with either of the other two materials, or it may be coupled to the other two materials through an intervening material. A device that is between two other devices may be directly connected to one or both of those devices, or it may be separated from both of the other two devices by one or more intervening devices.

As used throughout this description, and in the claims, a list of items joined by the term “at least one of” or “one or more of” can mean any combination of the listed terms. For example, the phrase “at least one of A, B or C” can mean A; B; C; A and B; A and C; B and C; or A, B and C. It is pointed out that those elements of a figure having the same reference numbers (or names) as the elements of any other figure can operate or function in any manner similar to that described, but are not limited to such.

In addition, the various elements of combinatorial logic and sequential logic discussed in the present disclosure may pertain both to physical structures (such as AND gates, OR gates, or XOR gates), or to synthesized or otherwise optimized collections of devices implementing the logical structures that are Boolean equivalents of the logic under discussion.

Techniques and architectures for providing prediction information at a processor are described herein. In the above description, for purposes of explanation, numerous specific details are set forth in order to provide a thorough understanding of certain embodiments. It will be apparent, however, to one skilled in the art that certain embodiments can be practiced without these specific details. In other instances, structures and devices are shown in block diagram form in order to avoid obscuring the description.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Some portions of the detailed description herein are presented in terms of algorithms and symbolic representations of operations on data bits within a computer memory. These algorithmic descriptions and representations are the means used by those skilled in the computing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the discussion herein, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Certain embodiments also relate to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs) such as dynamic RAM (DRAM), EPROMS, EEPROMs, magnetic or optical cards, or any type of media suitable for storing electronic instructions, and coupled to a computer system bus.

In one or more first embodiments, a processor comprises a first execution engine of a first core, the first execution engine to perform an execution of a first software process, first prediction circuitry of the first core, the first prediction circuitry to generate first microarchitectural prediction state information based on the execution, and first prediction state manager circuitry coupled to the first prediction circuitry, the first prediction state manager circuitry to receive a first indication of a first context switch which is to stop the execution of the first software process with the first core, and save a version of the first microarchitectural prediction state information, based on the first indication, to a repository which is external to the first core.

In one or more second embodiments, further to the first embodiment, the first prediction state manager circuitry is to automatically save the version of the first microarchitectural prediction state information independent of any explicit software instruction.

In one or more third embodiments, further to the first embodiment or the second embodiment, the processor comprises the repository.

In one or more fourth embodiments, further to any of the first through third embodiments, the processor is to be coupled to a random access memory, and a portion of the random access memory is to comprise the repository.

In one or more fifth embodiments, further to any of the first through fourth embodiments, the first prediction circuitry comprises one of a conditional branch predictor, an indirect branch predictor, a branch target buffer, or a return predictor.

In one or more sixth embodiments, further to any of the first through fifth embodiments, the processor further comprises a cryptographic engine to perform an encryption process to generate the version of the first microarchitectural prediction state information.

In one or more seventh embodiments, further to any of the first through sixth embodiments, the first core further comprises a context tagger circuit to tag the version of the first microarchitectural prediction state information with tag information which identifies the first software process.

In one or more eighth embodiments, further to any of the first through seventh embodiments, the first prediction state manager circuitry is to save the version of the first microarchitectural prediction state information to the repository based on an operational mode of the processor, wherein the operational mode is to selectively enable the processor to save microarchitectural state of the first prediction circuitry.

In one or more ninth embodiments, further to any of the first through eighth embodiments, the first prediction state manager circuitry is further to receive a second indication of a second context switch which is to resume the execution of the first software process, and recover the first microarchitectural prediction state information from the repository based on the second indication.

In one or more tenth embodiments, further to the ninth embodiment, the second context switch is to resume the execution of the first software process with the first core, and based on the second indication, the first prediction state manager circuitry is to recover the first microarchitectural prediction state information to the first prediction circuitry.

In one or more eleventh embodiments, a method comprises receiving a first indication of a first context switch by a processor, wherein the first context switch is to stop an execution of a first software process with a first core of the processor, wherein first prediction circuitry of the first core generates first microarchitectural prediction state information based on the execution of the first software process, and based on the first indication, automatically saving a version of the first microarchitectural prediction state information to a repository which is external to the first core.

In one or more twelfth embodiments, further to the eleventh embodiment, the processor comprises the repository.

In one or more thirteenth embodiments, further to the eleventh embodiment or the twelfth embodiment, the processor is coupled to a random access memory, and a portion of the random access memory comprises the repository.

In one or more fourteenth embodiments, further to any of the eleventh through thirteenth embodiments, the first prediction circuitry comprises one of a conditional branch predictor, an indirect branch predictor, a branch target buffer, or a return predictor.

In one or more fifteenth embodiments, further to any of the eleventh through fourteenth embodiments, automatically saving the version of the first microarchitectural prediction state information comprises encrypting the first microarchitectural prediction state information.

In one or more sixteenth embodiments, further to any of the eleventh through fifteenth embodiments, automatically saving the version of the first microarchitectural prediction state information comprises providing to the repository tag information which identifies the first software process.

In one or more seventeenth embodiments, further to any of the eleventh through sixteenth embodiments, the version of the first microarchitectural prediction state information is automatically saved to the repository based on an operational mode of the processor, wherein the operational mode selectively enables the processor to save microarchitectural state of the first prediction circuitry.

In one or more eighteenth embodiments, further to any of the eleventh through seventeenth embodiments, the method further comprises receiving a second indication of a second context switch by the processor, wherein the second context switch is to resume the execution of the first software process, and based on the second indication, recovering the first microarchitectural prediction state information from the repository.

In one or more nineteenth embodiments, further to the eighteenth embodiment, the second context switch is to resume the execution of the first software process with the first core, and based on the second indication, the first microarchitectural prediction state information is recovered to the first prediction circuitry.

In one or more twentieth embodiments, a system comprises processor comprising a first execution engine of a first core, the first execution engine to perform an execution of a first software process, first prediction circuitry of the first core, the first prediction circuitry to generate first microarchitectural prediction state information based on the execution, and first prediction state manager circuitry coupled to the first prediction circuitry, the first prediction state manager circuitry to receive a first indication of a first context switch which is to stop the execution of the first software process with the first core, and automatically save a version of the first microarchitectural prediction state information, based on the first indication, to a repository which is external to the first core, and a main memory coupled to the processor.

In one or more twenty-first embodiments, further to the twentieth embodiment, the processor comprises the repository.

In one or more twenty-second embodiments, further to the twentieth embodiment or the twenty-first embodiment, a portion of the main memory is to comprise the repository.

In one or more twenty-third embodiments, further to any of the twentieth through twenty-second embodiments, the first prediction circuitry comprises one of a conditional branch predictor, an indirect branch predictor, a branch target buffer, or a return predictor.

In one or more twenty-fourth embodiments, further to any of the twentieth through twenty-third embodiments, the processor further comprises a cryptographic engine to perform an encryption process to generate the version of the first microarchitectural prediction state information.

In one or more twenty-fifth embodiments, further to any of the twentieth through twenty-fourth embodiments, the first core further comprises a context tagger circuit to tag the version of the first microarchitectural prediction state information with tag information which identifies the first software process.

In one or more twenty-sixth embodiments, further to any of the twentieth through twenty-fifth embodiments, the first prediction state manager circuitry is to automatically save the version of the first microarchitectural prediction state information to the repository based on an operational mode of the processor, wherein the operational mode is to selectively enable the processor to save microarchitectural state of the first prediction circuitry.

In one or more twenty-seventh embodiments, further to any of the twentieth through twenty-sixth embodiments, the first prediction state manager circuitry is further to receive a second indication of a second context switch which is to resume the execution of the first software process, and recover the first microarchitectural prediction state information from the repository based on the second indication.

In one or more twenty-eighth embodiments, further to the twenty-seventh embodiment, the second context switch is to resume the execution of the first software process with the first core, and based on the second indication, the first prediction state manager circuitry is to recover the first microarchitectural prediction state information to the first prediction circuitry.

In one or more twenty-ninth embodiments, one or more non-transitory computer-readable storage media have stored thereon instructions which, when executed by one or more processing units, cause the one or more processing units to perform a method comprising receiving a first indication of a first context switch by a processor, wherein the first context switch is to stop an execution of a first software process with a first core of the processor, wherein first prediction circuitry of the first core generates first microarchitectural prediction state information based on the execution of the first software process, and based on the first indication, automatically saving a version of the first microarchitectural prediction state information to a repository which is external to the first core.

In one or more thirtieth embodiments, further to the twenty-ninth embodiment, the processor comprises the repository.

In one or more thirty-first embodiments, further to the twenty-ninth embodiment or the thirtieth embodiment, the processor is coupled to a random access memory, and a portion of the random access memory comprises the repository.

In one or more thirty-second embodiments, further to any of the twenty-ninth through thirty-first embodiments, the first prediction circuitry comprises one of a conditional branch predictor, an indirect branch predictor, a branch target buffer, or a return predictor.

In one or more thirty-third embodiments, further to any of the twenty-ninth through thirty-second embodiments, automatically saving the version of the first microarchitectural prediction state information comprises encrypting the first microarchitectural prediction state information.

In one or more thirty-fourth embodiments, further to any of the twenty-ninth through thirty-third embodiments, automatically saving the version of the first microarchitectural prediction state information comprises providing to the repository tag information which identifies the first software process.

In one or more thirty-fifth embodiments, further to any of the twenty-ninth through thirty-fourth embodiments, the version of the first microarchitectural prediction state information is automatically saved to the repository based on an operational mode of the processor, wherein the operational mode selectively enables the processor to save microarchitectural state of the first prediction circuitry.

In one or more thirty-sixth embodiments, further to any of the twenty-ninth through thirty-fifth embodiments, the method further comprises receiving a second indication of a second context switch by the processor, wherein the second context switch is to resume the execution of the first software process, and based on the second indication, recovering the first microarchitectural prediction state information from the repository.

In one or more thirty-seventh embodiments, further to the thirty-sixth embodiment, the second context switch is to resume the execution of the first software process with the first core, and based on the second indication, the first microarchitectural prediction state information is recovered to the first prediction circuitry.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description herein. In addition, certain embodiments are not described with reference to any particular programming language. It will be appreciated that a variety of programming languages may be used to implement the teachings of such embodiments as described herein.

Besides what is described herein, various modifications may be made to the disclosed embodiments and implementations thereof without departing from their scope. Therefore, the illustrations and examples herein should be construed in an illustrative, and not a restrictive sense. The scope of the invention should be measured solely by reference to the claims that follow.

What is claimed is:

1. A processor comprising:
a first execution engine of a first core, the first execution engine to perform an execution of a first software process;
first prediction circuitry of the first core, the first prediction circuitry to generate first microarchitectural prediction state information based on the execution; and
first prediction state manager circuitry coupled to the first prediction circuitry, the first prediction state manager circuitry to:
receive a first indication of a first context switch which is to stop the execution of the first software process with the first core; and
save a version of the first microarchitectural prediction state information, based on the first indication, to a repository which is external to the first core.

2. The processor of claim 1, wherein the first prediction state manager circuitry is further to:
receive a second indication of a second context switch which is to resume the execution of the first software process; and
recover the first microarchitectural prediction state information from the repository based on the second indication.

3. The processor of claim 1, wherein the first prediction state manager circuitry is to automatically save the version of the first microarchitectural prediction state information independent of any explicit software instruction.

4. The processor of claim 1, wherein the processor comprises the repository.

5. The processor of claim 1, wherein:
the processor is to be coupled to a random access memory; and
a portion of the random access memory is to comprise the repository.

6. The processor of claim 1, wherein the first prediction circuitry comprises one of a conditional branch predictor, an indirect branch predictor, a branch target buffer, or a return predictor.

7. The processor of claim 1, further comprising a cryptographic engine to perform an encryption process to generate the version of the first microarchitectural prediction state information.

8. The processor of claim 1, wherein the first core further comprises a context tagger circuit to tag the version of the first microarchitectural prediction state information with tag information which identifies the first software process.

9. The processor of claim 1, wherein the first prediction state manager circuitry is to save the version of the first microarchitectural prediction state information to the repository based on an operational mode of the processor, wherein the operational mode is to selectively enable the processor to save microarchitectural state of the first prediction circuitry.

10. A method comprising:
receiving a first indication of a first context switch by a processor, wherein the first context switch is to stop an execution of a first software process with a first core of the processor, wherein first prediction circuitry of the first core generates first microarchitectural prediction state information based on the execution of the first software process; and
based on the first indication, automatically saving a version of the first microarchitectural prediction state information to a repository which is external to the first core.

11. The method of claim 10, further comprising:
receiving a second indication of a second context switch by the processor, wherein the second context switch is to resume the execution of the first software process; and
based on the second indication, recovering the first microarchitectural prediction state information from the repository.

12. The method of claim 10, wherein:
the processor is coupled to a random access memory; and
a portion of the random access memory comprises the repository.

13. The method of claim 10, wherein the first prediction circuitry comprises one of a conditional branch predictor, an indirect branch predictor, a branch target buffer, or a return predictor.

14. The method of claim 10, wherein automatically saving the version of the first microarchitectural prediction state information comprises encrypting the first microarchitectural prediction state information.

15. The method of claim 10, wherein automatically saving the version of the first microarchitectural prediction state information comprises providing to the repository tag information which identifies the first software process.

16. A system comprising:
processor comprising:
a first execution engine of a first core, the first execution engine to perform an execution of a first software process;
first prediction circuitry of the first core, the first prediction circuitry to generate first microarchitectural prediction state information based on the execution; and
first prediction state manager circuitry coupled to the first prediction circuitry, the first prediction state manager circuitry to:
receive a first indication of a first context switch which is to stop the execution of the first software process with the first core; and
automatically save a version of the first microarchitectural prediction state information, based on the first indication, to a repository which is external to the first core; and
a main memory coupled to the processor.

17. The system of claim 16, wherein the first prediction state manager circuitry is further to:
receive a second indication of a second context switch which is to resume the execution of the first software process; and
recover the first microarchitectural prediction state information from the repository based on the second indication.

18. The system of claim 16, wherein the first prediction circuitry comprises one of a conditional branch predictor, an indirect branch predictor, a branch target buffer, or a return predictor.

19. The system of claim 16, the processor further comprising a cryptographic engine to perform an encryption process to generate the version of the first microarchitectural prediction state information.

20. The system of claim 16, wherein the first core further comprises a context tagger circuit to tag the version of the first microarchitectural prediction state information with tag information which identifies the first software process.
